(19) United States
(12) Patent Application Publication
(10) Pub. No.: US 2016/0117703 A1
(43) Pub. Date: Apr. 28, 2016

(54) Large-Scale Customer-Product Relationship Mapping and Contact Scheduling

(71) Applicant: Staples, Inc., Framingham, MA (US)

(72) Inventors: Taraknath Woddi, Renton, WA (US); Chandrasekhar Ganduri, North Grafton, MA (US); Begli Nursahedov, Waltham, MA (US); Dustin Lehr, Arvada, CO (US); Curtis Todd Breithaupt, Boulder, CO (US); Stephen Woundy, Framingham, MA (US); Daniel Cy Doyle, Thornton, CO (US); Anvesh SatiShivaSharan, Wayland, MA (US)

(21) Appl. No.: 14/735,064

(22) Filed: Jun. 9, 2015

Related U.S. Application Data
(60) Provisional application No. 62/067,328, filed on Oct. 22, 2014.

(51) Int. Cl. G06Q 30/02

(52) U.S. Cl. CPC G06Q 30/0204

(57) ABSTRACT

In an example embodiment, a method retrieves a customer product-class mapping that maps a customer identifier of each of a multiplicity of customers to 1) a customer tier, 2) a product class associated with an online, retail, and/or phone sales channel, and 3) a plurality of variables characterizing an interaction of the customer with the product class via the online, retail, and/or phone sales channel. The method generates a predictive score for each unique combination of the customer identifier, the customer tier, and the product class using predetermined online sales channel rules, predetermined retail sales channel rules, and/or predetermined phone sales channel rules, respectively, and the plurality of variables. The method selects a first set of customers from the multiplicity of the customers based on the predictive score and a revenue generated from the each unique combination and generates a schedule for contacting the first set of customers.

### CROSS-REFERENCE TO RELATED APPLICATION

This application claims the benefit under 35 U.S.C. §119(e) of U.S. Provisional Patent Application No. 62/067,328, entitled “Rule-Based Probabilistic Algorithm for Large-Scale Non-Linear Customer-Product Relationship” filed Oct. 22, 2014, the entire contents of which are incorporated herein by reference.

### BACKGROUND

The present disclosure relates to mapping customer-product relationships.

Customer-product mapping is an industry-related question that many are trying to answer with limited success. In particular, so far existing solutions have not been able to effectively (a) identify the individual customers/groups who are potential buyers and prioritize them for reaching out, (b) identify the customer base which cannot be influenced to make a purchase (regardless of the amount of effort exerted by the seller), (c) map the customers who have been identified as potential buyers and prioritized in a list to the exact products that are being sought after, and (d) facilitate customer reach-out efforts based on the consolidation of past purchases, potential purchases, proposed products, and store inventory.

Moreover, in many cases, the mappings that are provided by existing solutions are full of errors, which can translate into an uninteresting product being presented to the user. This in turn leads to disengagement and divergence from a customer transaction.

As a result, many industry giants are using ineffective and inefficient vendor-provided methods for matching products and customers. These methods are ineffective at least in part because of the lack of integration between statistical, probabilistic, and data engineering efforts. These methods are only capable of considering a limited amount of data, such as only the product browsing cycles, to suggest particular products.

Other limitations and obstacles have prevented an effective solution to this problem from being developed include the cost of large-scale training of individuals (e.g., account managers) for an effective implementation, management requirements and constraints, and process security.

### SUMMARY

The innovative technology disclosed in this document addresses the above-noted limitations.

In one innovative aspect, the technology includes a computer-implemented method comprising retrieving from a data store a customer product-class mapping that maps a customer identifier of each of a multiplicity of customers to 1) a customer tier, 2) a product class interacted with by the customer via one or more of an online sales channel, a retail sales channel, and a phone sales channel, and 3) a plurality of variables characterizing an interaction of the customer associated with the customer identifier with the product class via the one or more of the online sales channel, the retail sales channel, and the phone sales channel; generating a predictive score for each unique combination of the customer identifier, the customer tier, and the product class using one or more of predetermined online sales channel rules, predetermined retail sales channel rules, and predetermined phone sales channel rules, respectively, and the plurality of variables; selecting a first set of customers from the multiplicity of the customers based on the predictive score and a revenue generated from the each unique combination; generating a schedule for contacting the first set of customers based on one or more of the predictive score and the revenue; and providing the schedule to a client device of a stakeholder for use by the stakeholder in contacting the first set of customers.

In another innovative aspect, the technology includes a computer system comprising one or more computer processors and one or more computer memories storing instructions that, when executed by the one or more computer processors, cause the computer system to perform operations including: retrieving from a data store a customer product-class mapping that maps a customer identifier of each of a multiplicity of customers to 1) a customer tier, 2) a product class interacted with by the customer via one or more of an online sales channel, a retail sales channel, and a phone sales channel, and 3) a plurality of variables characterizing an interaction of the customer associated with the customer identifier with the product class via the one or more of the online sales channel, the retail sales channel, and the phone sales channel; generating a predictive score for each unique combination of the customer identifier, the customer tier, and the product class using one or more of predetermined online sales channel rules, predetermined retail sales channel rules, and predetermined phone sales channel rules, respectively, and the plurality of variables; selecting a first set of customers from the multiplicity of the customers based on the predictive score and a revenue generated from the each unique combination; generating a schedule for contacting the first set of customers; and providing the schedule to a client device of a stakeholder for use by the stakeholder in contacting the first set of customers.

Other aspects include corresponding systems, methods and apparatus, including computer program products. It should be noted that the language used in the present disclosure to describe these systems, methods and apparatus has been principally selected for readability and instructional purposes, and not to limit the scope of the subject matter disclosed herein.

One or more of the embodiments described can also include the following features: aggregating customer data associated with each customer of the multiplicity of the customers from one or more data stores storing data related to the online sales channel by retrieving, from the one or more data stores, first product identifiers reflecting products purchased by the customer using the online sales channel, retrieving, from the one or more data stores, second product identifiers reflecting products that were added to a virtual cart that was subsequently abandoned without having purchased the one or more products, the virtual cart being associated with the online sales channel, retrieving, from one or more data stores, third product identifiers reflecting product pages of products that were viewed by the customer but were not purchased using the online sales channel, generating an entry for the customer product-class mapping for the customer identifier associated with the customer using the first product identifiers reflecting the products purchased by the customer, the second product identifiers reflecting the products added to the virtual cart, and the third product identifiers reflecting the products that were viewed by the customer but were not purchased, and storing the entry in an aggregated data store storing the customer product-class mapping; determining product classes for the products associated with the first product identifiers, the second product identifiers, and the third product identifiers; retrieving customer tier data describing the customer tier of the customer; and categorizing the customer by each unique product class and customer tier combination; that the plurality of variables characterizing the interaction of the customer regarding a particular product includes one or more of browsing for product price, browsing for product features, browsing for product reviews, comparing the product with other products, and reviewing product details; that generating the predictive score for the each unique combination of the customer identifier, the customer tier, and the product class using the predetermined online sales channel rules and the plurality of variables comprises: estimating time spent by the customer on each of the plurality of variables associated with a particular product that the customer has indicated interest in using the online sales channel; allocating weights to the time spent by the customer on each of the plurality of the variables based on the predetermined online sales channel rules; and generating the predictive score for the each unique combination of the customer identifier, the customer tier, and the product class based on the weights allocated to the time spent by the customer on each of the plurality of variables; determining, for the customer identifier of each customer of the multiplicity of the customers, a visit cadence score based on a number of visits by the customer to one or more pages of one or more products; determining, for the customer identifier of each customer of the multiplicity of the customers, a purchase cadence score based on product purchase history associated with the customer identifier; determining, for the customer identifier of each customer of the multiplicity of the customers, a revenue cadence score customer cadence score based on amount of revenue generated from purchases by the customer; combining, for the customer identifier of each customer of the multiplicity of the customers, the visit cadence score, the purchase cadence score, and the revenue cadence score into an overall cadence score for the customer identifier; selecting a second set of customers from the multiplicity of the customers based on overall cadence scores associated with the second set of customers; injecting the second set of customers into the schedule, which includes the first set of customers; selecting a second set of customers from the multiplicity of the customers based on one or more of a visit cadence score, a purchase cadence score, and a revenue cadence score; injecting the second set of customers into the schedule, which includes the first set of customers that the first set of customers have higher priority than the second set of customers and the schedule is sorted based on the higher priority; registering a plurality of stakeholder accounts for a plurality of stakeholders including the stakeholder, each stakeholder of the plurality of stakeholders being assigned to a group of customer identifiers associated with customers; selecting for each stakeholder account of the plurality, a first subset of customer identifiers from the group of customer identifiers assigned to that stakeholder account based on 1) a predictive score for each unique combination of each customer identifier, customer tier, and product class using one or more of the predetermined online sales channel rules, the predetermined retail sales channel rules, and the predetermined phone sales channel rules, respectively, and the plurality of variables, and 2) a revenue generated from each unique combination, wherein selecting includes selecting the first set of customers from the multiplicity of the customers based on the predictive score and the revenue generated from the each unique combination; selecting for each stakeholder account of the plurality, a second subset of customers identifiers from the group of customer identifiers assigned to that stakeholder based on cadence scores associated with the customer identifiers of the second subset; generating, for each stakeholder account of the plurality, a schedule for contacting certain customers of the group of customers associated with the stakeholder account based on a combination of the first subset of customers and the second subset of customers associated with the stakeholder account; providing, to a client device of each stakeholder account of the plurality, the schedule generated for that stakeholder account; aggregating customer data of a plurality of customers from an online data store reflecting the online sales channel, a retail data store reflecting the retail sales channel, and a call center data store reflecting the phone sales channel; statistically analyzing the aggregated customer data of the plurality of customers to determine the multiplicity of customers from the plurality of customers whose interest in products offered by a business merchant fall within a certain interval; aggregating customer data associated with each customer of the multiplicity of the customers from one or more data stores storing data related to the retail sales channel and the phone sales channel by: determining a total number of orders associated with the customer, determining a number of items included in each of the orders; determining revenue generated by each of the orders, determining revenue generated by each item included in each of the orders, determining any discounts applied to each of the orders; generating an entry for the customer product-class mapping for the customer identifier associated with the customer using the total number of orders associated with the customer, the number of items included in each of the orders, the revenue generated by each of the orders, the revenue generated by each item included in each of the orders, and any discounts applied to each of the orders, and storing the entry in an aggregated data store storing the customer product-class mapping.

The innovative technology also includes various methods and apparatus, including computer program products, as well as other aspects. The innovative technology described is particularly advantageous in a number of respects. For example, it provides the capability to list out the customers on the basis of their prominence and potential to buy. Having identified the individuals and groups of customers, it uses a unique a frequency interval for repeating the communication process. The communication process involves automated, algorithmically-chosen, highly-probable products that the customer may buy depending on the behavioral pattern shown by past buyers and product researchers.

The technology achieves the long-time, multi-fold, pending goals unattainable by others in the industry. In particular, the invention identifies the individual customers/groups who are potential buyers and prioritizes them for reaching out. The invention includes an algorithm that identifies the customer base which cannot be influenced with any effort to make a purchase. The invention connects the exact products that are being sought after to the customers, who have been identified as potential buyers and prioritized in a list. Finally, the invention provides and consolidates the past purchases, potential purchases, proposed products, and store inventory to be pursued, into a multi-dimensional mapping to facilitate customer reach-out efforts.

The technology also includes various algorithms and automated processes for continuous simulation and identification of the delta changes with next to negligible manual cumbersome effort to dig the data. It also includes a method of analyzing product browsing cycles and suggesting the particular products. The present invention uses a rule-based algorithm that looks at non-linear patterns and finds specific thresholds, and uses heuristics to determine the appropriate time to approach the customer with his/her preferred products.

The above list of features and advantages is not all-inclusive and many additional features and advantages are within the scope of the present disclosure. Moreover, it should be noted that the language used in the present disclosure has been principally selected for readability and instructional purposes, and not to limit the scope of the subject matter disclosed herein.

### BRIEF DESCRIPTION OF THE DRAWINGS

The present disclosure is illustrated by way of example, and not by way of limitation in the figures of the accompanying drawings in which like reference numerals are used to refer to similar elements.

FIG. 1 is a block diagram of an example system for large-scale customer-product relationship mapping and contact scheduling.

FIGS. 2A-2C are flow diagrams of the example system.

FIG. 3 is a block diagram of a method 300 for customer reach-out based on a generated schedule.

FIG. 4 is a flowchart of an example method 400 for generating and providing schedule.

FIG. 5A is a flowchart of an example method for aggregating customer data associated with each of a multiplicity of the customers from one or more data stores (e.g., databases, web servers, etc.) storing data related to the online sales channel.

FIG. 5B is a flowchart of an example method for aggregating customer data associated with each of a multiplicity of the customers from one or more data stores (e.g., databases, web servers, etc.) storing data related to the retail and phone sales channels.

FIG. 6 is a flowchart of an example method for categorizing a multiplicity of customers by each unique product class and customer tier combination.

FIG. 7 is a flowchart of an example method for generating a predictive score.

FIG. 8 is a flowchart of an example method for providing a customized schedule to a stakeholder.

FIG. 9 is a flowchart of an example method for generating a schedule for contacting a high-value subset of customers associated with each stakeholder.

FIG. 10 is a block diagram of an example system for large-scale customer-product relationship mapping and contact scheduling.

FIG. 11 is a block diagram of an example computing system.

### DETAILED DESCRIPTION

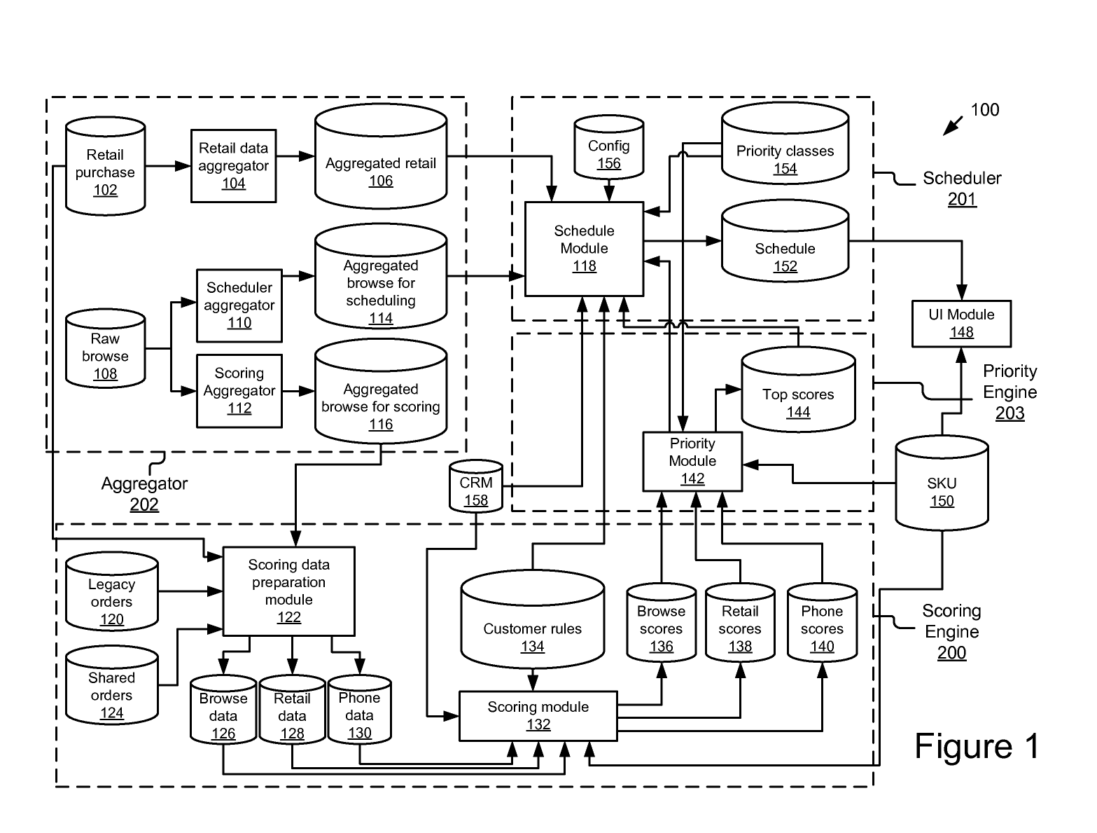

FIG. 1 is a block diagram of an example system 100 for large-scale customer-product relationship mapping and contact scheduling. FIG. 1 includes a scoring engine 200, a scheduler 201, an aggregator 202, and a priority engine 203, and various other components such as a UI module 148, a SKU data store 150, and/or a CRM 158, which are coupled for communication with one another.

The aggregator 202 is executable to aggregate and processing raw data, and store the aggregated data for retrieval. The aggregator 202 accumulates the data from various information sources. In some embodiments, the information sources may include retail purchase data source(s), such as the retail purchase data store 102, and raw browse data source(s) such as raw browse data store 108. The retail purchase data store 102 stores data reflecting purchases by customers in physical stores using rewards accounts. In some instances, the retail purchase data may be stored by point-of-sale systems and/or other systems associated with retail sales. The retail purchase data may describe the product identifiers of the products that were purchased, the date and time the purchases were made, the customer identifiers associated with the purchases, and/or any other related data, etc. The raw browse data store 102 stores data reflecting customers' actions in interacting with an online sales channel. The online sales channel is embodied by an e-commerce application providing a virtual market place associated with a merchant (e.g., Staples™) to customers to browse and purchase products. The virtual market place is, in some embodiments, linked to the retail and phone sales channels offered by the same merchant.

The retail data aggregator is executable to aggregate the retail purchase data, standardize it, and store it into the aggregated retail data store 106 for efficient access and/or retrieval by the schedule module 118, as discussed in further detail elsewhere herein. The schedule aggregator 110 and the scoring aggregator 112 may each aggregate and standardize raw browse data from the raw browse data store and store in a corresponding aggregated data store (e.g., the data stores 114 and 116, respectively), as discussed in further detail elsewhere herein.

By way of further example, the data collection process by the aggregator 202 performed for the online, retail, and/or phone sales channels (e.g., online, store-based, and phone customers). For all channels, the aggregator 202 aggregates information such as customer IDs, customer tier (e.g., reward tier), products bought over certain timeframe (e.g., over last 5/10/15 orders, during a certain period of time, etc.), repeat flag (reflecting if multiple repeat purchases have been made), etc. The timeframe of the purchases is an indicator of the frequency of the repetitions.

Further, for the online sales channel, the aggregator 202 aggregates data describing products purchased, products not bought but added to a virtual cart, and products not bought but viewed, etc. A “Product View” interaction and an “Add To Cart (ATC)” interaction have established definitions in the data aggregation process, and the dates on which a given customer viewed products and/or added products to cart are vital signs that are used to optimize the schedules generated herein.

Regarding the retail and/or phone channels, the aggregator 202 aggregates purchase data reflecting discounts available on products bought over a certain timeframe (e.g., last 5/10/15 orders, during a certain period of time, etc.), any product identifiers describing cross-sell products related to previously purchased products, any product identifiers reflecting supplies and accessories related to previously purchased products, etc. For any missing data, the aggregator 202 may aggregate product identifiers describing related products, cross-sell products, supplies and accessories in the same product class, etc.

In some embodiments, the data is correlated by the aggregator 202 with the applicable customer identifiers reflecting the customers that performed the actions. In some embodiments, only data meeting certain action thresholds (e.g., page views, purchases, etc.) is aggregated, although other variations are also possible and contemplated. In addition, in some embodiments, certain product criteria may be required to be met in order for data about that product to be aggregated to reduce the time and intensity of the processing that must be performed by the aggregator 202, especially considering that thousands, hundreds of thousands, etc., of product may be processed. For example, a SKU may need to have a minimum price to be aggregated, or may need to belong to a certain SKU category.

The aggregator 202 may standardize the raw data (e.g., format, classify, stagger, group, etc.) aggregated by it and stage it for retrieval by the scoring engine 200 and/or the scheduler 201. By way of further example and not limitation, during the aggregation phase, the aggregator 202 calculates visits by a customer (reflected by that customer's identifier) to product pages associated with products. In some embodiments, absent page view data, as a heuristic the aggregator 202 may consider the number of orders by a customer identifier as visits and the number of product purchases (independent and repeat) as product views (e.g., during a certain period), and store/provide them as such as aggregated data for retrieval by the scoring module 132.

The aggregator 202 is coupled for communication to the other components of the system 100, including the scheduler 201, the scoring engine 200, the CRM 158, etc.

The scoring engine 200 is executable to generate and update data for the customer product-class mapping for use by the priority engine 203 and/or scheduler 201, as discussed elsewhere herein. In generating data for the mapping, the scoring engine 200 may process the aggregated data and scores for unique combinations of customer identifiers, customer tiers, and product classifications. The scores are generated for each of the sales channels based on unique rules associated with each of those channels (e.g., retail, online, and phone).

The scoring engine 200 may perform data preparation on the aggregated data in preparation for generating the scores for each channel. In some embodiments, the scoring engine 200 includes a scoring data preparation module 122 that retrieves data from the retail purchase data store 102, the aggregated data store for scoring 116, the legacy orders data store 120, and the shared orders data store 124. For each channel (e.g., browse, retail, and phone), the scoring data preparation module 122 may standardize the data for processing by the scoring module 132.

In some embodiments, using the retrieved data, the scoring data preparation module 122 generates a list of all the products bought by each customer with dates (e.g., by ordered date, shipped date, delivery date, etc.) and products that have not been bought but added to cart and/or viewed (e.g., by descending product views). The scoring data preparation module 122 may store each set of prepared data in a corresponding data store. For example, the scoring engine 200 may store the prepped browse data in the browse data store 126, the prepped retail data in the retail data store 128, and the prepped phone data in the phone data store 130.

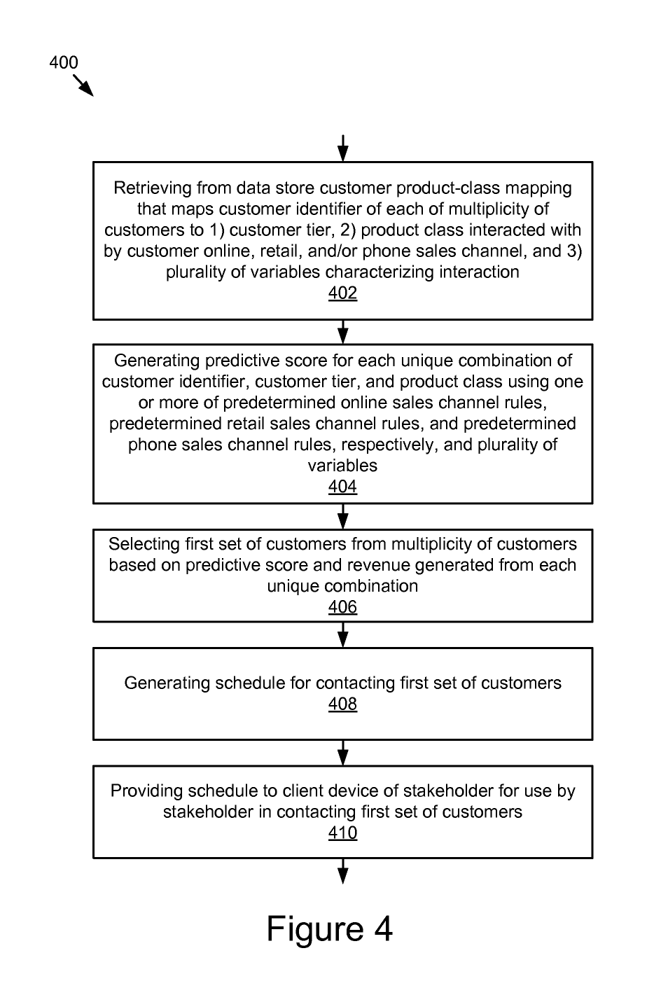

The scoring module 132 is executable to generate, for each unique combination of customer ID, customer tier, and product class, a score for each sales channel, as discussed in further detail elsewhere herein, such as with respect to FIG. 4. The scoring module 132 is coupled to the browse, retail, and phone data stores 126, 128, and 130 to retrieve the data prepped by the scoring data preparation module 122. The scoring module 132 uses this data to compute the various scores.

In some embodiments, for the online sales channel, the scoring engine 200 may generate the scores using the below equations. In particular, the scoring data preparation module 122 may prepare the data by performing brute force analytics of laying out scatter plots to look for outliers, trends, and biases. The scoring data preparation module 122 may use a residual sum of squares (RSS) method to select a certain relevant portion of the data. For instance, the method may select the customers that fall within a certain closeness to mean (e.g., mean and confidence interval, such as 2-sigma, 95% CI). In this example, the method selects 95% of the mined data thus deleting the bottom and top 2.5% respectively.

Once the data has been prepped, the scoring module 132 compute the scores by modeling the relationship between the input variables and the output function by computing coefficients of an equation and identifying the relationship between products purchased and the browsing purpose (e.g., price, features, details, comparisons, reviews, number of offerings similar to the product, visits, views, etc.).

Example variables of the equation may include:

y=Number of units of a particular product ordered;

x₁=Time spent on browsing price;

x₂=Time spent on browsing for features;

x₃=Time spent on browsing for reviews;

x₄=Time spent on comparing products;

x₅=Time spent on product details page; and

ε=Random error.

The above question may in some cases take the form of the following consolidated linear equation:

y=b₀+b₁*x₁+b₂*x₂+b₃*x₃+b₄*x₄+b₅*x₅+ε

In the above question, coefficients b₀, b₁, etc., may be derived for a multiple linear regression (MLR) model. By way of further example, the coefficients may be derived using “R” code and the following equations:

$${b}_{1} = \frac{{\sum }_{i = 1}^{n} ( {x}_{1} ( i ) - {x}_{1 μ} ) * ( y ( i ) - {y}_{μ} )}{{\sum }_{i = 1}^{n} {( {x}_{1} ( i ) - {x}_{1 μ} )}^{2}}$$

$${b}_{2} = \frac{{\sum }_{i = 1}^{n} ( {x}_{2} ( i ) - {x}_{2 μ} ) * ( y ( i ) - {y}_{μ} )}{{\sum }_{i = 1}^{n} {( {x}_{2} ( i ) - {x}_{2 μ} )}^{2}}$$

The model in some instances may begin with a single linear regression model that considers the response of each input variable on the total orders (y) with calculation of intercepts and slopes as follows:

y=b₀₁+b₁*x₁

y=b₀₂+b₂*x₂

The random error may be computed as follows:

ε=Σᵢ₌₁ⁿ(y(i)−y_{μ})²

Intercepts may be calculated as follows:

b₀₁=y−[b₁*x₁+ε]

b₀₂=y−[b₂*x₂+ε]

The scoring module 132 may apply a null hypothesis of the coefficients for each variable (H₀:b₁=b₂= . . . =0), in which case if Null is rejected then the alternate hypothesis stands accepted. Using the above equations, the F-statistic test would turn out to be close to “1” if there is no relationship between response and predictor. Otherwise it would be much greater than 1.

The RSS may be computed using the following equation:

$$RSS = {\sum }_{i = 1}^{n} {( y ( i ) - y ( ∅ ) )}^{2}$$

In the above equation, y(i)=actual observation and y(ø)=calculated line (or plane) value using the linear regression equation.

The scoring module 132 may group the customer ids into unique product-class customer-tier groups and then compute scores for each unique combination and channel. The scoring module 132 may process the data associated with each of the product-class customer-tier groups to generate a score. By way of example and not limitation, a customer associated with a customer ID may belong to a Gold customer tier and purchase a product in a product class #500, and the scoring module 132 generates a unique score for that product-class, customer tier, customer ID combination based on the variables discussed herein. The scoring module 132 retrieves a set of customer rules associated with the channel that it is generating a score for, and applies the rules to the relevant data when generating the score.

In some embodiments, the scoring module 132 may include specialized “R-code” adapted to each of the product-class customer-tier groups and executed for that particular group's dataset, which allows for the possibility of migration of a customer ID to another unique combination (e.g., a Gold rewards customer becomes a Platinum rewards customer (and possibly begins purchasing products with higher margin of profit)).

As a further example, each product class may have a customer group for an account manager customer tier (e.g., Gold, Platinum, etc.). In this example, the group designation combines the product class ID “500” with the reward tier designation “Platinum” (e.g., Group name=“500-Platinum”). Based on the data accumulated, the scoring module 132 includes an equation (e.g., linear, non-linear, etc.) that is representative of its character. As discussed further herein, the system 100 may promote, recommend, etc., products associated with each unique group based on the findings of the product purchase criteria and customer buying pattern(s) identified from the output of the scoring module 132 algorithm.

In some embodiments, when generating the scores, the scoring module 132 establishes a relationship of each variable with the response function. The scoring module 132 may calculate an F-statistics value. If this value is very high corresponding to the p-value, then it will result in rejection of NULL hypothesis and the acceptance that a relationship exists. The strength in relationship between the variable, (predictor) and response function, is indicated by calculating the RSE and adjusted R² explaining the variances. The contribution of each predictor to the response function is examined by t-statistics. To determine the largest contributor, the scoring module 132 may perform a single linear regression. The scoring module 132 may further identify the synergy among the predictors. Non-linear terms along with interaction may often end up giving the lowest p-value. The MLR equation with lowest p-value thus gets accepted as the likelihood function for the product-consumer group in consideration.

The scoring engine 200 may limit the data processed to a certain period of time. In an example, 38 days of sales data may be substantial for developing rule-based product mapping model for retail customers, although it should be understood that a different date range (e.g., past two weeks, 30, 60, 90, 180, past year, etc.) may also be used.

The priority engine 203 is executable to determine the priority of the customers based on the scores generated by the scoring engine 200. The priority engine 203 includes a priority module 142 and a top scores data store 144. The priority module 142 is executable to combine the browse, retail, and phone score(s) associated with each unique combination into a total score. The priority module 142 may retrieve the given scores from the browse, retail, and phone scores databases 136, 138, and 140, and combine them into a total score where applicable, select the total scores meeting a certain threshold as top scores, and store the top scores into a top scores database 144.

In some embodiments, the priority module 142 evaluates whether, for a given unique product-class customer-tier combination, a score exists for more than one channel, and if so, combines the scores into a total score. The priority module 142 may access information about a product class from the SKU data store 150. In some embodiments, if a customer identifier has transactions in two or three of the sales channels, and the scoring engine 200 applies a predefined precedence to sort the transactions. For example, the scoring engine 200 may apply the following order: online interactions>cross-sell interactions>interactions involving supplies and accessories. In other embodiments, other sorting algorithms may be used. If a score exists for a single channel only, the priority module 142 uses that score as for the total score and evaluates it as a top score based thereon.

In some embodiments, the priority module 142 sums a given list generated from the online, retail, and/or phone channels and sorts select entries from the customer product-class mapping in a particular order (e.g., descending order). The sorting may be performed per the score for the product classes and revenue generated in recent past, as discussed elsewhere herein.

Entries from an example customer-product class mapping are provided below, although it should be understood that the mapping may take other forms and include additional or other data and may be stored in single data store or distributed across data stores.

| | | | | | Total | | | | | | | | |
|---|---|---|---|---|---|---|---|---|---|---|---|---|---|
| | | | | | revenue | | | | | | | | |
| Group | Customer | Time | | | in | Total | Total | | Product | Page | Cart | | |
| (tier/class) | identifier | spent | Tiers | Units | group | revenue | visits | Visits | views | views | adds | Orders | Score |
| GOLD-568 | 5346563314 | 211 | G10 | 0 | 0 | 466.03 | 152 | 1 | 2 | 2 | 0 | 0 | 1 |
| GOLD-568 | 5368109244 | 15 | G10 | 0 | 0 | 0 | 1 | 1 | 2 | 2 | 0 | 0 | 2 |
| GOLD-568 | 5373990521 | 249 | PG5 | 1 | 27.36 | 27.36 | 12 | 2 | 6 | 10 | 1 | 1 | 1 |
| GOLD-568 | 5385707244 | 66 | G10 | 1 | 20.59 | 236.53 | 2 | 2 | 1 | 2 | 1 | 1 | 1 |
| GOLD-568 | 5387115636 | 0 | PG5 | 0 | 0 | 339.13 | 16 | 1 | 1 | 1 | 0 | 0 | 1 |
| GOLD-568 | 5395084527 | 482 | G10 | 1 | 11.99 | 403.14 | 50 | 2 | 3 | 10 | 0 | 1 | 2 |
| GOLD-568 | 5605719201 | 61 | G10 | 1 | 7.99 | 151.27 | 1 | 1 | 1 | 2 | 1 | 1 | 2 |
| GOLD-568 | 5669183690 | 31 | PG5 | 0 | 0 | 471.35 | 10 | 1 | 1 | 1 | 0 | 0 | 2 |
| GOLD-568 | 5755845277 | 6 | G10 | 0 | 0 | 220.56 | 2 | 1 | 0 | 1 | 0 | 0 | 2 |
| GOLD-568 | 5759266520 | 373 | G10 | 0 | 0 | 92.38 | 1 | 1 | 4 | 4 | 0 | 0 | 0 |
| GOLD-569 | 23798028 | 89 | PG5 | 0 | 0 | 322.11 | 3 | 1 | 0 | 1 | 0 | 0 | 1 |
| GOLD-569 | 2109251708 | 4 | G10 | 0 | 0 | 173.85 | 20 | 1 | 0 | 0 | 0 | 0 | −4 |
| GOLD-569 | 2379020973 | 145 | PG5 | 0 | 0 | 382.73 | 5 | 2 | 1 | 4 | 2 | 0 | 0 |
| GOLD-569 | 2712237177 | 18 | G10 | 0 | 0 | 96.41 | 3 | 1 | 0 | 1 | 0 | 0 | 0 |
| GOLD-569 | 2720989454 | 90 | PG5 | 0 | 0 | 416.23 | 10 | 1 | 4 | 4 | 0 | 0 | −1 |
| GOLD-569 | 2843758968 | 26 | G10 | 0 | 0 | 431.95 | 1 | 1 | 1 | 1 | 0 | 0 | 1 |
| GOLD-569 | 2851566758 | 18 | G10 | 0 | 0 | 199.61 | 1 | 1 | 1 | 1 | 0 | 0 | 0 |
| GOLD-569 | 2901112629 | 0 | G10 | 0 | 0 | 97.56 | 9 | 1 | 1 | 1 | 0 | 0 | −1 |
| GOLD-569 | 3486587946 | 97 | PG5 | 0 | 0 | 372.33 | 66 | 1 | 4 | 4 | 0 | 0 | −1 |
| GOLD-569 | 4025389505 | 73 | G10 | 0 | 0 | 394.68 | 4 | 1 | 3 | 3 | 0 | 0 | 0 |
| GOLD-569 | 4047523735 | 12 | G10 | 0 | 0 | 199.27 | 14 | 1 | 0 | 1 | 0 | 0 | 0 |
| GOLD-569 | 4075867574 | 49 | PG5 | 1 | 33.39 | 174.8 | 1 | 1 | 1 | 2 | 1 | 1 | 1 |
| GOLD-569 | 5332520229 | 320 | G10 | 4 | 119.96 | 379.75 | 4 | 1 | 4 | 12 | 2 | 2 | 1 |
| GOLD-570 | 219655529 | 0 | PG5 | 0 | 0 | 321.05 | 33 | 1 | 1 | 1 | 0 | 0 | 5 |
| GOLD-570 | 553340589 | 0 | G10 | 0 | 0 | 0 | 1 | 1 | 1 | 1 | 0 | 0 | 5 |
| GOLD-570 | 1998227589 | 439 | PG5 | 0 | 0 | 382.9 | 2 | 2 | 4 | 6 | 1 | 0 | 5 |
| GOLD-570 | 2001004734 | 32 | G10 | 0 | 0 | 1338.35 | 97 | 1 | 1 | 1 | 0 | 0 | 5 |
| GOLD-570 | 2165236791 | 102 | G10 | 0 | 0 | 133.98 | 1 | 1 | 2 | 0 | 0 | 0 | 5 |
| GOLD-570 | 2721101174 | 32 | G10 | 0 | 0 | 0 | 3 | 1 | 1 | 1 | 0 | 0 | 5 |
| GOLD-570 | 3455954127 | 160 | G10 | 1 | 19.19 | 228.4 | 58 | 2 | 7 | 8 | 1 | 1 | 5 |
| GOLD-570 | 3956448819 | 106 | PG5 | 0 | 0 | 2207.13 | 12 | 1 | 1 | 1 | 1 | 0 | 5 |
| GOLD-570 | 4017357569 | 10 | G10 | 0 | 0 | 0 | 3 | 1 | 1 | 1 | 0 | 0 | 5 |
| GOLD-570 | 4052140748 | 94 | G10 | 0 | 0 | 666.59 | 43 | 1 | 1 | 1 | 0 | 0 | 5 |
| GOLD-570 | 4089797148 | 0 | G10 | 0 | 0 | 83.07 | 5 | 1 | 1 | 1 | 0 | 0 | 5 |
| GOLD-570 | 4193300987 | 90 | G10 | 0 | 0 | 387.12 | 26 | 1 | 3 | 3 | 0 | 0 | 5 |
| GOLD-570 | 4205883582 | 21 | G10 | 0 | 0 | 229.99 | 5 | 1 | 1 | 1 | 0 | 0 | 5 |
| GOLD-570 | 4217988247 | 0 | PG5 | 0 | 0 | 67.73 | 2 | 1 | 1 | 1 | 0 | 0 | 5 |
| GOLD-570 | 5675366081 | 116 | PG5 | 0 | 0 | 360.48 | 15 | 1 | 2 | 2 | 0 | 0 | 5 |
| GOLD-570 | 5677524406 | 288 | G10 | 0 | 0 | 0 | 2 | 1 | 6 | 10 | 1 | 0 | 5 |
| GOLD-571 | 2482099 | 120 | PG5 | 4 | 26.76 | 26.76 | 2 | 2 | 1 | 8 | 3 | 2 | 0 |
| GOLD-571 | 4666509 | 88 | G10 | 1 | 23.99 | 204.07 | 85 | 2 | 1 | 2 | 1 | 1 | 2 |
| GOLD-571 | 8584856 | 31 | G10 | 0 | 0 | 247.24 | 9 | 1 | 1 | 1 | 0 | 0 | 3 |
| GOLD-571 | 8595969 | 6 | PGD | 0 | 0 | 81.98 | 23 | 1 | 1 | 1 | 0 | 0 | 3 |
| GOLD-571 | 11182946 | 41 | G10 | 0 | 0 | 313.46 | 13 | 1 | 2 | 2 | 0 | 0 | 1 |
| GOLD-571 | 11958279 | 22 | PG5 | 0 | 0 | 354.23 | 6 | 1 | 2 | 2 | 0 | 0 | 1 |
| GOLD-571 | 12588810 | 1009 | PGD | 0 | 0 | 251.35 | 23 | 1 | 1 | 1 | 0 | 0 | 2 |
| GOLD-571 | 13438296 | 99 | PG5 | 1 | 7.09 | 44.66 | 1 | 1 | 0 | 2 | 0 | 1 | 2 |
| GOLD-571 | 21940077 | 73 | G10 | 1 | 12.39 | 170.52 | 7 | 2 | 2 | 3 | 1 | 1 | 1 |
| GOLD-571 | 23732704 | 167 | G10 | 20 | 99.8 | 209.25 | 1 | 1 | 2 | 6 | 1 | 1 | 0 |

The scheduler 201 is executable to generate a schedule for each registered stakeholder (e.g., account manager). The scheduler 201 includes the schedule module 118, the config data store 156, the priority classes data store 154, and the schedule data store 152. The schedule module 118 is executable to generate a schedule including ranked list(s) of customer identifiers for each stakeholder. The schedule module 118 stores the data generated by it into the schedule data store 152 and/or provides it to another module, such as the UI module 148.

The schedule module 118 can evaluate the cycle of purchasing by each customer identifier (representing a customer) to determine optimal timing for contacting a certain customer. A customer may be contacted via a variety of means, include by phone, via electronic message (e.g., email, chat, SMS, etc.), etc. In some embodiments, the scheduler 188 can evaluate historical data associated with each customer identifier including frequency of the purchases associated with the customer identifier.

The schedule module 118 generates, for each stakeholder identifier, a schedule describing ranked list of customer identifiers based on the top scores 144. The schedule module 118 may retrieve data about the customer identifiers (e.g., accounts) and the stakeholder identifier (e.g., profile) from the CRM 158. In some embodiments, the schedule module 118 retrieves aggregated transactional data for browse, retail and phone channels from one or more information sources, such as the data store 114 and 106, for example. The schedule module 118 may prune the data retrieved by it to remove noise, outliers, etc.

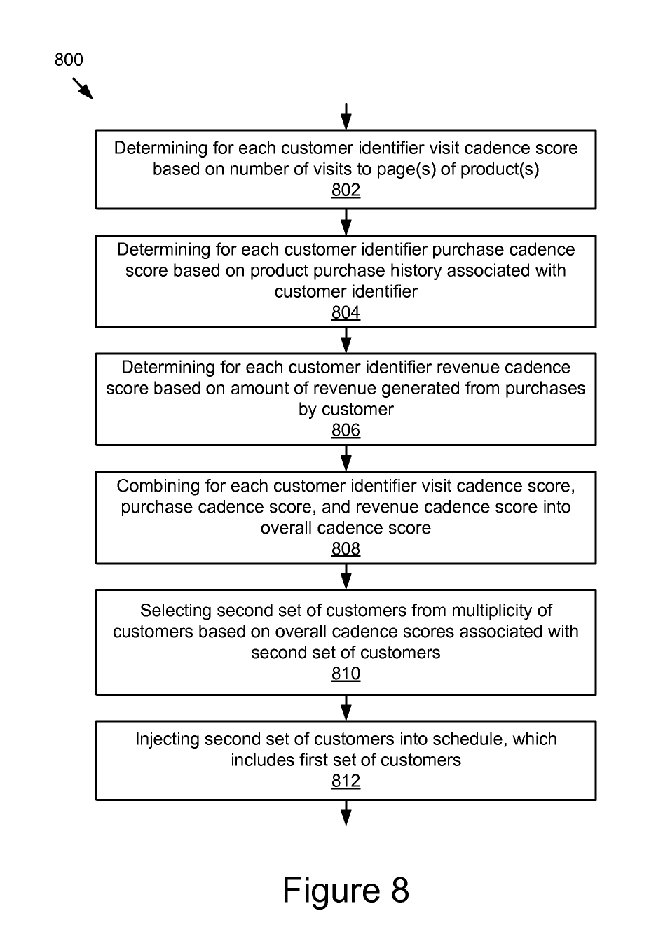

In some embodiments, the schedule module 118 determines a cadence for each customer identifier/account. For instance, for each account, the schedule module 118 may determine visit, purchase and revenue cadence scores, and then combine the three scores to an overall cadence score using a sigmoidal function, as discussed elsewhere herein. Operations for computing cadence scores and selecting customer identifiers based there is discussed elsewhere herein, such as with respect to FIG. 8.

The schedule module 118 may determine the schedulable accounts for each stakeholder identifier (e.g., account manager) based on customer rules retrieved from the customer rules data store 134. The customer rules may define the business rules unique to each customer account and the schedule module 118 may apply the rules to generate the schedule for a given account manager. By way of example, for each account manager, the schedule module 118 may generate and provide a list of accounts including one or more of a first segment of accounts determined based on the top scores generated by the priority module 142, and a second segment of accounts determined based on the cadence scores. In implementations involving both segments, the schedule module 118 may selects a first set of customers based on priority and a second set of customers from the multiplicity of the customers based on one or more of a visit cadence score, a purchase cadence score, and a revenue cadence score and injects the second set of customers into the schedule, which includes the first set of customers. In further example, the schedule module 118 may interweave the segments based on one or more rule and cadence strategies.

By way of further example and not limitation, the business needs of a merchant may drive the persuasion of specific products with potential customers. The scheduler 201 is configured to provide curated lists of customers to for display on client devices of account managers. The curated lists are generated to include customers with the highest propensity to satisfy the particular business need (e.g., purchase products from certain product classes, etc.). For instance, assume the current business need is to sell furniture products for next 8 weeks.

The schedule module 118 may execute the following sequential process to identify the customers with a persuasion toward furniture. A list of classes for furniture (for that matter any business need) is input by and received from stakeholders. For instance, using a corresponding interface, a manager may input the furniture product classes that should be promoted. The scheduler 201 will retrieve and rank customer identifiers associated with 1) the product classes; and 2) the highest scores for the product classes. The output of this processing (e.g., customer ID, class ID, and rank score) is fed to a scheduling algorithm of the schedule module 118, which evaluates the purchase and browsing cadence of the customers, and generates the schedule (e.g., appropriate list) of customers, which is formatted and/or transmitted by the UI module 148 to the client device of each of the account managers. In some instances, a schedule may be transmitted upon receiving a schedule request, may be transmitted upon login into an account manager system portal, may be transmitted via electronic message according to a certain schedule (e.g., on a daily basis), etc.

In some embodiments, the schedule (e.g., including the customer list) provided to a given stakeholder (e.g., account manager) may contain the customers already considered for the business need at the top (considered list) followed by a list of customers (consolidated list) being pursued for the business need based on priority (selected from high rank, about to purchase, intent shown through browsing, and falling-off curve). In some instances, various business needs are cyclically pursued and the system 100 updates data of the mapping on a regular basis for use by the scheduler 118.

The UI module 148 receives and replies to content requests. The UI module 148 may retrieve schedule data generated by the schedule module 118, retrieve data from the SKU data store 150, prepare the schedule customized for a given stakeholder based on the retrieved data, and transmit the schedule to the client device of the stakeholder for display.

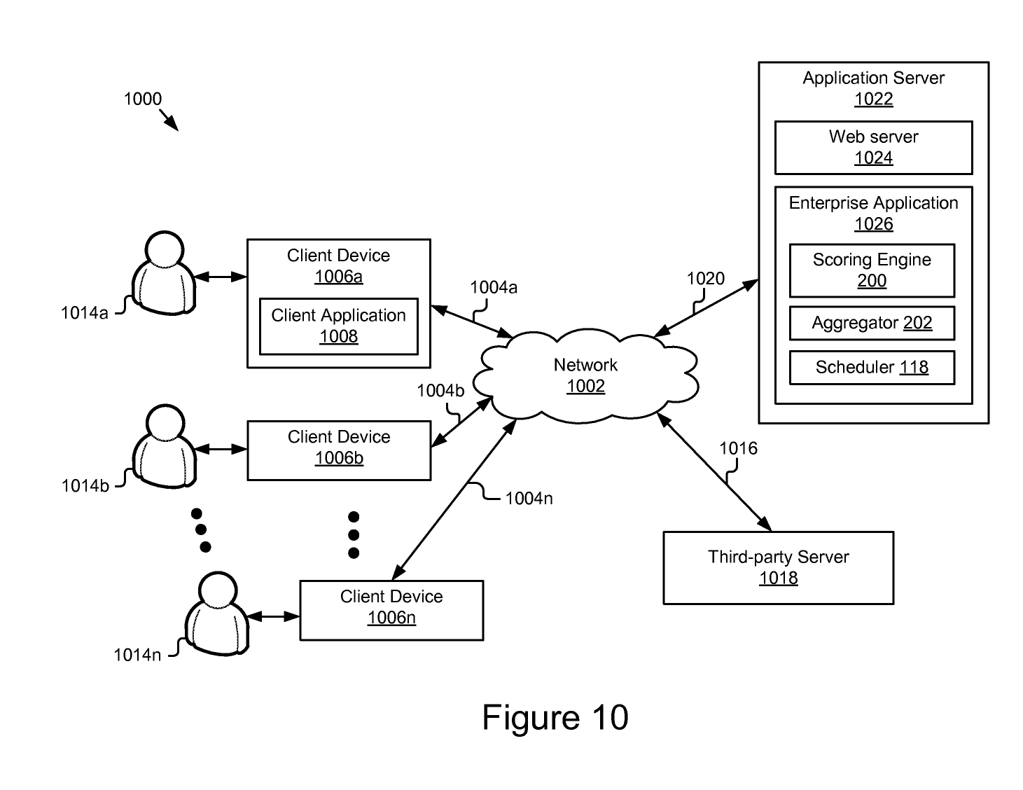

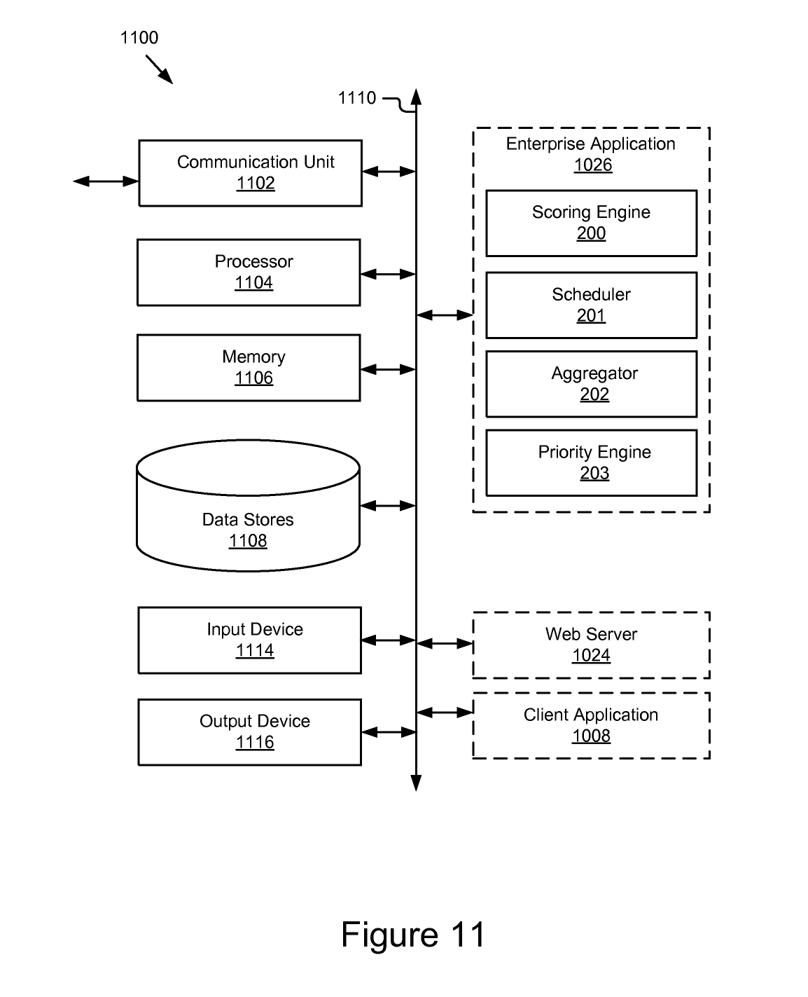

In some embodiments, the UI module 148 is associated with a web server, such as the web server 1024 depicted in FIGS. 10 and 11. The UI module may provide data forming an account manager portal associated with the CRM 158. In this embodiment, stakeholders can use the account manager portal for customer reach-out and follow-up with prescriptions for products and predictions of particular business group progressions. In some further embodiments, a stakeholder may use the account manager portal to access other data associated with a given customer or customer order, such as the date of purchase, customer ID, order number, SKU's in the Order, revenue from the order, revenue from individual SKUs, coupons/discounts applied to individual SKUs, coupons/discounts applied to the order, discounted or free product attached to purchase of another product, etc.

It should be understood that the UI module 148 may embody other communication platforms, such as a messaging or data service (e.g., email, SMS, chat, API, etc.). For instance, the UI module 148 or another component of the system (e.g., the scheduler 201) may manager and triggering targeted electronic notifications (e.g., email, SMS, social media, etc.) with product recommendations to the high-value customers in the schedule data at an effective adaptable frequency.

In some embodiments, the data presented to a given account manager has been aggregated within a particular timeframe (e.g., the past 24 hours), or is real-time or near-real time (e.g., less than an hour old). In some embodiments, the schedule includes 1) products that were previously purchased and 2) products that were not bought but added to cart or not bought but viewed, with hyperlinks selectable to land on the corresponding product pages and make virtual cart additions along with provisions to place orders. Other variations are also possible and contemplated.

The SKU data store 150 is an information source storing SKU pricing (e.g., pricing for the products, such as the list, discount, and/or dynamic price for each SKU), SKU categories describe the category(ies) to which a SKU belongs, etc. The categories may be hierarchical in nature, and a give SKU may belong to more than one category.

The CRM 158 reflects a customer relations management information source storing the accounts and relationships between one or more vendors and/or customers. The CRM 158 may store data associated with sales, marketing, customer service, and technical support. The vendor may employ a plurality of individuals (e.g., account mangers) that are each responsible for managing certain customer accounts. Data reflecting the relationship between the account manager profiles and the profiles of the customer accounts may be stored in the CRM 158.

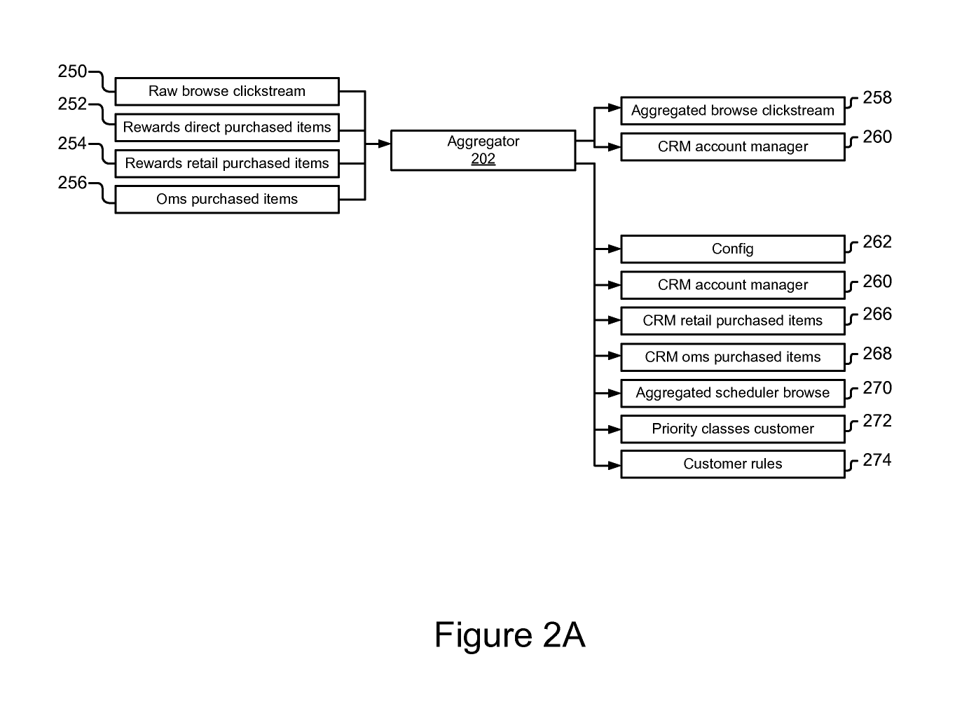

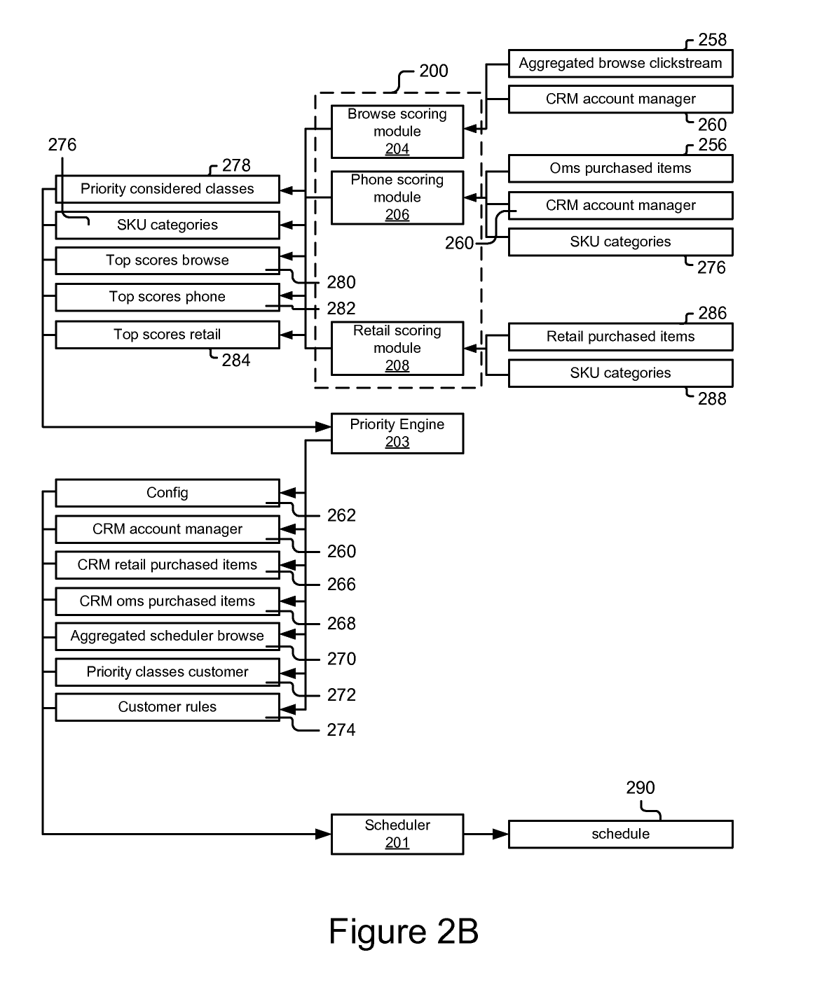

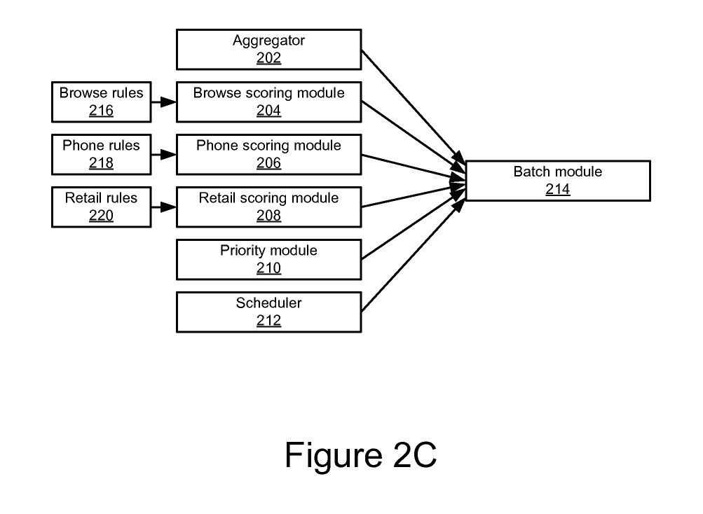

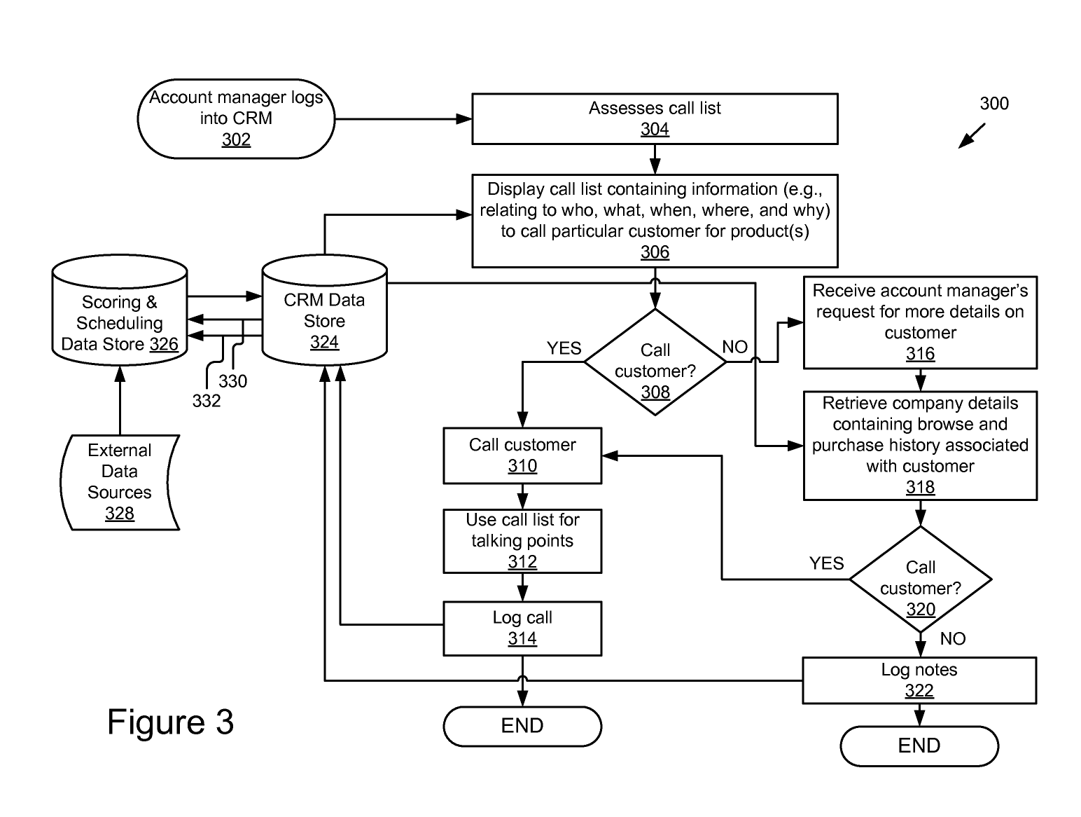

FIGS. 2A-2B are data flow diagrams of the example system 100, and FIG. 3C is a code dependency diagram of the example system 100. As shown in FIG. 2A, the aggregator 202 may retrieve raw browse clickstream data 250 describing user interactions with a virtual marketplace, rewards direct purchased items describing products purchased by customers by phone, rewards retail purchase items describing products purchased by customers in-store, and oms purchased items describing products process by the order management system associated with the virtual marketplace.

The aggregator 202 processes this data into aggregated browse clickstream data 258 and CRM account manager data 260, and stores this data accordingly for use by the browse scoring module as shown in FIG. 2B. The aggregator 202 and processes this data outputs config data 262, CRM retail purchase items data 266, CRM oms purchased items data 268, aggregated scheduler browse data 270, priority classes customer data 272, and customer rules data 274, and stores this data accordingly for use by the other components of the system 100, as shown in FIG. 2B.

Referring to FIG. 2B, the browse scoring module 204 receives aggregated browse clickstream data 258 and CRM account manager data 260, the phone scoring module 206 receives oms purchased items data 256, CRM account manager data 260, and the SKU category data 276, and the retail scoring module 208 receives retail purchased items data 286 and SKU categories data 288. Each of these modules 204, 206, and 208 processes their respective retrieved data and updates the priority considered classes data 278, SKU categories data 276, top scores browse data 280, top scores phone data 282, and/or top scores retail data 284. The priority engine 203 receives and processes this data, and updates config data 262, CRM account manager data 260, CRM retail purchase items data 266, CRM oms purchased items data 268, aggregated scheduler browse data 270, priority classes customer data 272, and/or customer rules data 274. The scheduler receives and uses this data to generate the schedule 290. In some embodiments, the components 250, 252, 254, 256, 258, 260, 262, 266, 268, 270, 272, 274, 276, 278, 280, 282, 284, 286, 288, and 290 embody tables that are updated by the aggregator 202, scoring engine 200, priority engine 203, and scheduler 201 based on the operations discussed herein.

As shown in FIG. 2C, the scheduler 201 may include a batch module 214. The batch module may be dependent upon, and trigger the operation of the aggregator 202, the browse scoring module 204, the phone scoring module 206, the retail scoring module 208, the priority module 210, and the scheduler 212. The browse scoring module 204, the phone scoring module 206, and the retail scoring module 208 may be dependent upon and use the browse rules 216, phone rules 218, and the retail rules 220 to perform their respective operations, as discussed in further detail elsewhere herein.

The methods 300-900 depicted in FIGS. 3-9, respectively, are now described. However, it should be understood that the methods 300-900 are provided by way of example, and that variations and combinations of these methods, as well as other methods, are contemplated. For example, in some embodiments, at least a portion of one or more of the methods 300-900 represent various segments of one or more larger methods and may be concatenated or various steps of these methods may be combined to produce other methods which are encompassed by the present disclosure. Additionally, it should be understood that various operations in the methods 300-900 may be iterative, and thus repeated as many times as necessary generate the results described herein. Further the ordering of the operations in the methods 300-900 is provided by way of example and it should be understood that various operations may occur earlier and/or later in the method without departing from the scope thereof.

FIG. 3 is a block diagram of a method 300 for customer reach-out based on a generated schedule. In block 302, the account manager logs into a CRM and in block 204, accesses a call list. Responsive thereto, the method 300 displays the call list in block 306. The call list reflects the schedule generated using the systems and methods discussed herein. The call list may include information relating to who, what, where, when, and why a particular customer should be called for a given product or product class.

In block 308, the method 300 determines whether to call a particular customer from the call list (responsive to a selection by the account manager). If yes, the method 300 calls the customer in block 310 and the account manager uses the call list for talking points in block 312. In block 314, the method 300 logs the call and the routine ends (e.g., returns to block 308 or another operation, terminates, etc.). If in block the determination is negative, the method 300 receives an account manager's request for more details on customer in block 316. Responsive thereto, the method 300 retrieves company details containing browse and purchase history associated with the customer in block 318, at which point the method 300 determines whether to call the customer in block 320. If the determination is affirmative in block 320, the method 300 proceeds to block 310 and the method 300 proceeds accordingly. If the determination in block 320 is negative, the method 300 logs notes input by the account manager for a given customer and then ends (e.g., returns to block 308 or another operation, terminates, etc.).

The method 300 may replicate the data stored in the CRM data store 324 in the scoring and scheduling data store 326. In some embodiments, the scoring and schedule data store 326 reflects the data stores described in FIG. 1 with respect to the aggregator 202, the scheduler 201, and/or the scoring engine 200, etc. In addition, data from other external data sources 328 may be aggregated into the scoring and schedule data store 326.

FIG. 4 is a flowchart of an example method 400 for generating and providing a schedule.

In block 402, the method 400 retrieves from a data store a customer product-class mapping that maps a customer identifier of each of a multiplicity of customers to 1) a customer tier, 2) a product class interacted with by the customer via one or more of an online sales channel, a retail sales channel, and a phone sales channel, and 3) a plurality of variables characterizing an interaction of the customer associated with the customer identifier with the product class via the one or more of the online sales channel, the retail sales channel, and the phone sales channel. Examples of the variables characterizing the interaction of the customer regarding a particular product include browsing for product price, browsing for product features, browsing for product reviews, comparing the product with other products, and/or reviewing product details, etc.

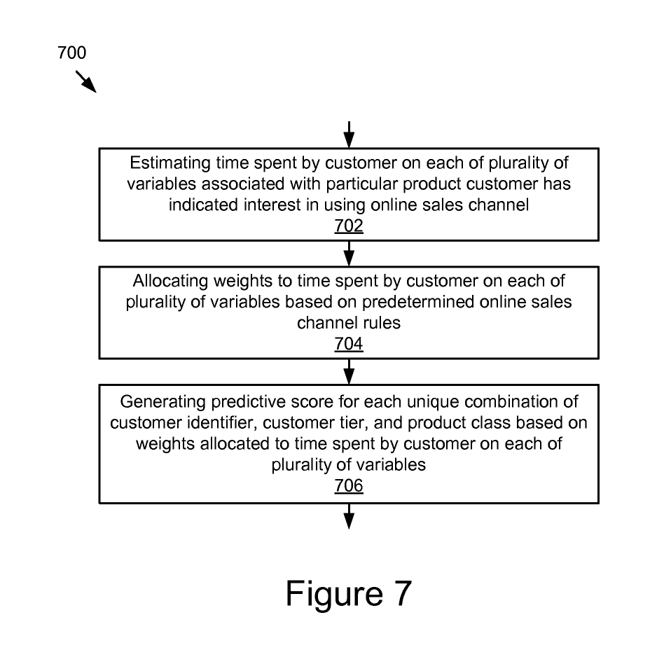

In block 404, the method 400, generates a predictive score for each unique combination of the customer identifier, the customer tier, and the product class using one or more of predetermined online sales channel rules, predetermined retail sales channel rules, and predetermined phone sales channel rules, respectively, and the plurality of variables. A further example method for generating the predictive score is described herein with respect to FIG. 7.

In block 406, the method 400 selects a first set of customers from the multiplicity of the customers based on the predictive score and a revenue generated from the each unique combination.

In block 408, the method 400 generates a schedule for contacting the first set of customers regarding products that the customers of the first set have indicated interest in.

In block 410, the method 400 provides the schedule to a client device of a stakeholder for use by the stakeholder in contacting the first set of customers regarding potential purchases.

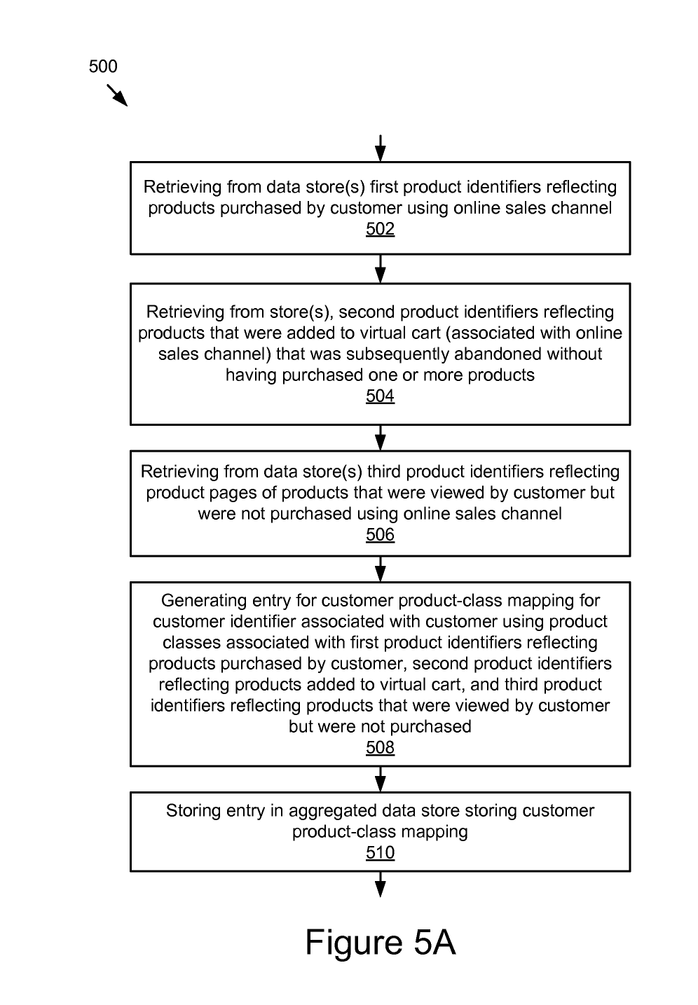

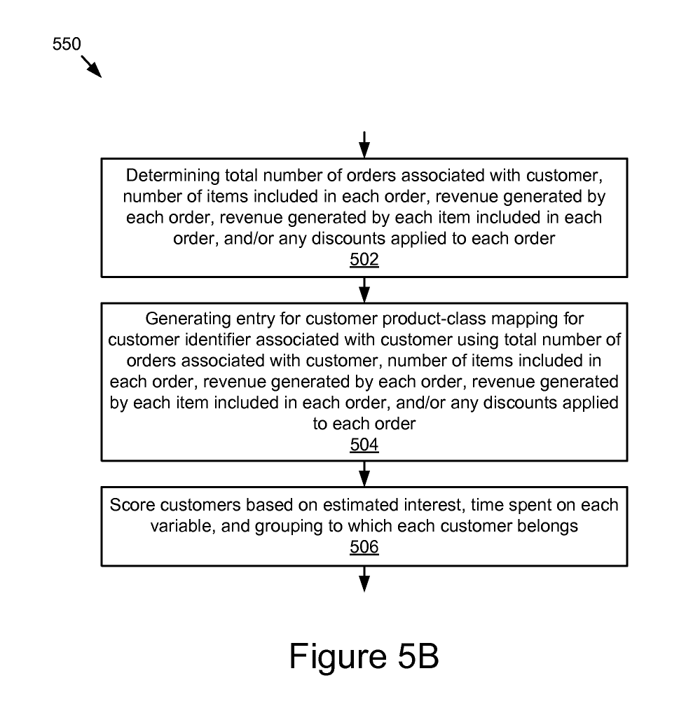

As discussed elsewhere herein, such as with respect to the aggregator 202, the aggregator 202 may aggregate customer data of a plurality of customers from an online data store reflecting the online sales channel, a retail data store reflecting the retail sales channel, and a call center data store reflecting the phone sales channel and statistically analyze the aggregated customer data of the plurality of customers to determine the multiplicity of customers from the plurality of customers whose interest in products offered by a business merchant fall within a certain interval. FIG. 5A is a flowchart of one such example method 500 for aggregating customer data associated with each of a multiplicity of the customers from one or more data stores (e.g., databases, web servers, etc.) storing data related to the online sales channel.

In block 502, the method 500 retrieves, from one or more data stores, first product identifiers reflecting products purchased by the customer using the online sales channel.

In block 504, the method 500 retrieves, from the one or more data stores, second product identifiers reflecting products that were added to a virtual cart that was subsequently abandoned without having purchased the one or more products, the virtual cart being associated with the online sales channel.

In block 506, the method 500 retrieves, from one or more data stores, third product identifiers reflecting product pages of products that were viewed by the customer but were not purchased using the online sales channel.

In block 508, the method 500 generates an entry for the customer product-class mapping for the customer identifier associated with the customer using product classes associated with the first product identifiers reflecting the products purchased by the customer, the second product identifiers reflecting the products added to the virtual cart, and the third product identifiers reflecting the products that were viewed by the customer but were not purchased; and

In block 510, the method 500 stores the entry in an aggregated data store storing the customer product-class mapping.

FIG. 5B is a flowchart of an example method 550 for aggregating customer data associated with each of a multiplicity of the customers from one or more data stores (e.g., databases, web servers, etc.) storing data related to the retail and phone sales channels.

In block 552, the method 550 determines a total number of orders associated with the customer, a number of items included in each of the orders, the revenue generated by each of the orders, the revenue generated by each item included in each of the orders, and/or any discounts applied to each of the orders.

In block 554, the method 550 generates an entry for the customer product-class mapping for the customer identifier associated with the customer using the total number of orders associated with the customer, the number of items included in each of the orders, the revenue generated by each of the orders, the revenue generated by each item included in each of the orders, and any discounts applied to each of the orders.

In block 556, the method 550 stores the entry in an aggregated data store storing the customer product-class mapping.

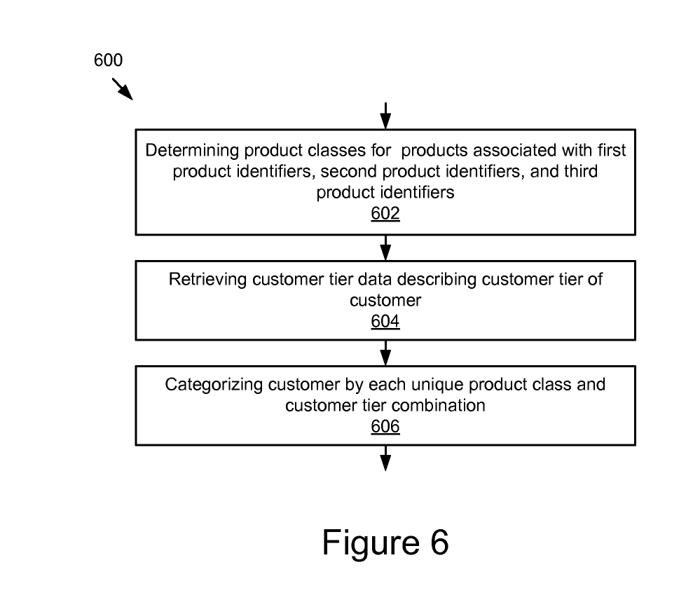

FIG. 6 is a flowchart of an example method 600 for categorizing the multiplicity of customers by each unique product class and customer tier combination.

In block 602, the method 600 determines product classes for the products associated with the first product identifiers, the second product identifiers, and the third product identifiers. In block 604, the method 600 retrieves customer tier data describing the customer tier of the customer. In block 606, the method categorizes the customer by each unique product class and customer tier combination.

FIG. 7 is a flowchart of an example method 700 for generating a predictive score. In block 702, the method 700 estimates time spent by the customer on each of the plurality of variables associated with a particular product that the customer has indicated interest in using the online sales channel. In block 704, the method 700 allocates weights to the time spent by the customer on each of the plurality of the variables based on the predetermined online sales channel rules. In block 706, the method 700 generates the predictive score for the each unique combination of the customer identifier, the customer tier, and the product class based on the weights allocated to the time spent by the customer on each of the plurality of variables.

FIG. 8 is a flowchart of an example method 800 for providing a customized schedule to a stakeholder.

In block 802, the method 800 determines, for the customer identifier of each customer of the multiplicity of the customers, a visit cadence score based on a number of visits by the customer to one or more pages of one or more products.

In block 804, the method 800 determines, for the customer identifier of each customer of the multiplicity of the customers, a purchase cadence score based on product purchase history associated with the customer identifier.

In block 806, the method 800 determines, for the customer identifier of each customer of the multiplicity of the customers, a revenue cadence score customer cadence score based on amount of revenue generated from purchases by the customer.

In block 808, the method 800 combines, for the customer identifier of each customer of the multiplicity of the customers, the visit cadence score, the purchase cadence score, and the revenue cadence score into an overall cadence score for the customer identifier.

In block 810, the method 800 selects a second set of customers from the multiplicity of the customers based on overall cadence scores associated with the second set of customers.

In block 812, the method 800 injects the second set of customers into the schedule, which includes the first set of customers. In some embodiments, the first set of customers have higher priority than the second set of customers and the schedule is sorted based on the higher priority.

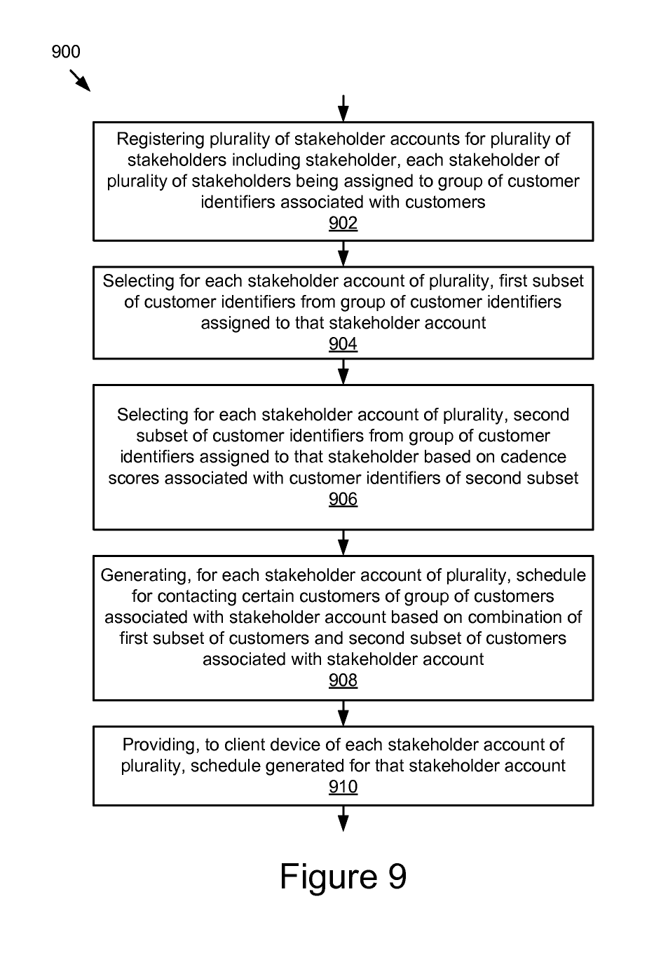

FIG. 9 is a flowchart of an example method 900 for generating a schedule for contacting a high-value subset of customers associated with each stakeholder.

In block 902, the method 900 registers a plurality of stakeholder accounts for a plurality of stakeholders including the stakeholder. Each stakeholder of the plurality of stakeholders is assigned to a group of customer identifiers associated with customers.

In block 904, the method 900 selects for each stakeholder account of the plurality, a first subset of customer identifiers from the group of customer identifiers assigned to that stakeholder account based on a predictive score for each unique combination of each customer identifier, customer tier, and product class and a revenue generated from each unique combination. The predictive score is generated using one or more of the predetermined online sales channel rules, the predetermined retail sales channel rules, and the predetermined phone sales channel rules, respectively, and the plurality of variables.

In block 906, the method 900 selects for each stakeholder account of the plurality, a second subset of customer identifiers from the group of customer identifiers assigned to that stakeholder based on cadence scores associated with the customer identifiers of the second subset.

In block 908, the method 900 generates, for each stakeholder account of the plurality, a schedule for contacting certain customers of the group of customers associated with the stakeholder account based on a combination of the first subset of customers and the second subset of customers associated with the stakeholder account.

In block 910, the method 900 provides, to a client device of each stakeholder account of the plurality, the schedule generated for that stakeholder account.

FIG. 10 is a block diagram of an example system 1000 for large-scale customer-product relationship mapping and contact scheduling. The illustrated system 1000 may include client devices 1006a . . . 1006n (also referred to herein individually and/or collectively as 1006), a third-party server 1018, and an application server 1022, which are electronically communicatively coupled via a network 1002 for interaction with one another, although other system configurations are possible including other devices, systems, and networks. For example, the system 1000 could include any number of client devices 1006, third-party servers 1018, application servers 1022, and other systems and devices.

The client devices 1006a . . . 1006n, and their components, may be coupled to the network 1002 via signal lines 1012a . . . 1012n. The application server 1022 and its components may be coupled to the network 1002 via signal line 1020. The third-party server 1018 and its components may be coupled to the network 1002 via signal line 1016. The users 1014a . . . 1014n may access one or more of the devices of the system 1000.

The network 1002 may include any number of networks and/or network types. For example, the network 1002 may include, but is not limited to, one or more local area networks (LANs), wide area networks (WANs) (e.g., the Internet), virtual private networks (VPNs), wireless wide area network (WWANs), WiMAX® networks, personal area networks (PANs) (e.g., Bluetooth® communication networks), various combinations thereof, etc. These private and/or public networks may have any number of configurations and/or topologies, and data may be transmitted via the networks using a variety of different communication protocols including, for example, various Internet layer, transport layer, or application layer protocols. For example, data may be transmitted via the networks using TCP/IP, UDP, TCP, HTTP, HTTPS, DASH, RTSP, RTP, RTCP, VOIP, FTP, WS, WAP, SMS, MMS, XMS, IMAP, SMTP, POP, WebDAV, or other known protocols.

The client device 1006 includes one or more computing devices having data processing and communication capabilities. The client device 1006 may couple to and communicate with other client devices 1006 and the other entities of the system 1000 via the network 1002 using a wireless and/or wired connection. Examples of client devices 1006 may include, but are not limited to, mobile phones, tablets, laptops, desktops, netbooks, server appliances, servers, virtual machines, TVs, etc. The system 1000 may include any number of client devices 1006, including client devices of the same or different type.

A plurality of client devices 1006a . . . 1006n are depicted in FIG. 10 to indicate that the application server 1022 and its components may aggregate information about and provide product suggestions to a multiplicity of users 1014a . . . 1014n on a multiplicity of client devices 1006a . . . 1006n. In some embodiments, a single user may use more than one client device 1006, which the application server 1022 may track and aggregate interaction data associated with the user through a variety of different channels including online, retail, and phone sales channels, as discussed elsewhere herein.

The application server 1022 may include a web server 1024 and an enterprise application 1026. In some configurations, the enterprise application 1026 may be distributed over the network 1002 on disparate devices in disparate locations or may reside on the same locations, in which case the client device 1006a and/or the application server 1022 may each include an instance of the enterprise application 1026 and/or portions thereof. The client devices 1006 may also store and/or operate other software such as a client application 1008, an operating system, other applications, etc., that are configured to interact with the application server 1022 via the network 1002.

As shown, the enterprise application 1026 may include a scoring engine 200, an aggregator 202, a scheduler 201, and a priority engine 203, which are discussed in further detail elsewhere herein.

The application server 1022 and the third-party server 1018 have data processing, storing, and communication capabilities, as discussed elsewhere herein. For example, the servers 1022 and/or 1018 may include one or more hardware servers, server arrays, storage devices and/or systems, etc. In some embodiments, the servers 1022 and/or 1018 may include one or more virtual servers, which operate in a host server environment.

Third-party server 1018 can host services such as a third-party application (not shown), which may be individual and/or incorporated into the services provided by the application server 1022.

It should be understood that the system 1000 illustrated in FIG. 10 is representative of an example system and that a variety of different system environments and configurations are contemplated and are within the scope of the present disclosure. For instance, various acts and/or functionality may be moved from a server to a client, or vice versa, data may be consolidated into a single data store or further segmented into additional data stores, and some embodiments may include additional or fewer computing devices, services, and/or networks, and may implement various functionality client or server-side. Further, various entities of the system may be integrated into a single computing device or system or divided into additional computing devices or systems, etc.

FIG. 11 is a block diagram of an example computing system 1100, which may represent the computer architecture of a client device 1006, a third-party server 1018, and/or an application server 1022, as depicted in FIG. 10, depending on the implementation.

As depicted in FIG. 11, the computing system 1100 may include an enterprise application 1026, a web server 1024, and a client application 1008, depending on the configuration. For instance, a client device 1006 may include one or more of the client application 1008 (which could incorporate various aspects of the enterprise application 1026 in some embodiments); and the application server 1022 may include the web server 120, the enterprise application 1026, and/or components thereof, although other configurations are also possible and contemplated.

The enterprise application 1026 includes computer logic executable by the processor 1104 to provide large-scale customer-product relationship mapping and contact scheduling, as discussed elsewhere herein. The enterprise application 1026 is coupled to the data stores 1108 to store, retrieve, and/or manipulate data stored therein and may be coupled to the web server 1024, the client application 1008, and/or other components of the system 100 to exchange information therewith. In the depicted embodiment, the enterprise application 1026 includes the scoring engine 200, the scheduler 201, the aggregator 202, and the priority engine 203.

The web server 1024 includes computer logic executable by the processor 1104 to methods content requests. The web server 1024 may include an HTTP server, a REST (representational state transfer) service, or other suitable server type. The web server 1024 may receive content requests (e.g., product search requests, HTTP requests) from client devices 1006, cooperate with the enterprise application 1026 to determine the content, retrieve and incorporate data from the data stores 1108, format the content, and provide the content to the client devices. In some embodiments, the web server 1024 includes the UI prep module 146 and the UI module 148, although other configurations are also possible and contemplated.

In some instances, the web server 1024 may format the content using a web language and provide the content to a corresponding client application 1008 for processing and/or rendering to the user for display. The web server 1024 may be coupled to the data stores 1108 to store retrieve, and/or manipulate data stored therein and may be coupled to the scheduler 201 to facilitate its operations. For example, the web server 1024 may allow a user on a client device 1006 to communicate with scheduler 201, the CRM 158, and/or the other components of the system 100.

The client application 1008 includes computer logic executable by the processor 1104 on a client device 1006 to provide for user interaction, receive user input, present information to the user via a display, and send data to and receive data from the other entities of the system 1000 via the network 1002. In some embodiments, the client application 1008 may generate and present user interfaces based at least in part on information received from the enterprise application 1026 and/or the web server 1024 via the network 1002. For example, a customer/user 1014 may use the client application 1008 to receive the product pages provided by the application server 1022, view various products available online, add products to a virtual cart, purchase products, receive discounts on products, etc. In some embodiments, the client application 1008 includes a web browser and/or code operable therein, a customized client-side application (e.g., a dedicated mobile app), a combination of both, etc.

As depicted, the computing system 1100 may include a processor 1104, a memory 1106, a communication unit 1102, an output device 1106, an input device 1104, and a data stores 1108, which may be communicatively coupled by a communication bus 1110. The computing system 1100 depicted in FIG. 11 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc. While not shown, the computing system 1100 may include various operating systems, sensors, additional processors, and other physical configurations. The processor 1104, memory 1106, communication unit 1102, etc., are representative of one or more of these components.

The processor 1104 may execute software instructions by performing various input, logical, and/or mathematical operations. The processor 1104 may have various computing architectures to method data signals (e.g., CISC, RISC, etc.). The processor 1104 may be physical and/or virtual, and may include a single core or plurality of processing units and/or cores. In some embodiments, the processor 1104 may be coupled to the memory 1106 via the bus 1110 to access data and instructions therefrom and store data therein. The bus 1110 may couple the processor 1104 to the other components of the computing system 1100 including, for example, the memory 1106, the communication unit 1102, the input device 1104, the output device 1106, and the data stores 1108.

The memory 1106 may store and provide access to data to the other components of the computing system 1100. The memory 1106 may be included in a single computing device or a plurality of computing devices. In some embodiments, the memory 1106 may store instructions and/or data that may be executed by the processor 1104. For example, the memory 1106 may store one or more of the enterprise application 1026, the web server 1024, the client application 1008, and their respective components, depending on the configuration. The memory 1106 is also capable of storing other instructions and data, including, for example, an operating system, hardware drivers, other software applications, databases, etc. The memory 1106 may be coupled to the bus 1110 for communication with the processor 1104 and the other components of computing system 1100.

The memory 1106 may include a non-transitory computer-usable (e.g., readable, writeable, etc.) medium, which can be any non-transitory apparatus or device that can contain, store, communicate, propagate or transport instructions, data, computer programs, software, code, routines, etc., for processing by or in connection with the processor 1104. In some embodiments, the memory 1106 may include one or more of volatile memory and non-volatile memory (e.g., RAM, ROM, hard disk, optical disk, etc.). It should be understood that the memory 1106 may be a single device or may include multiple types of devices and configurations.

The bus 1110 can include a communication bus for transferring data between components of a computing device or between computing devices, a network bus system including the network 1002 or portions thereof, a processor mesh, a combination thereof, etc. In some embodiments, the enterprise application 1026, web server 1024, client application 1008, and various other components operating on the computing system/device 1000 (operating systems, device drivers, etc.) may cooperate and communicate via a communication mechanism included in or implemented in association with the bus 1110. The software communication mechanism can include and/or facilitate, for example, inter-method communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The communication unit 1102 may include one or more interface devices (I/F) for wired and wireless connectivity among the components of the system 1000. For instance, the communication unit 1102 may include, but is not limited to, various types known connectivity and interface options. The communication unit 1102 may be coupled to the other components of the computing system 1100 via the bus 1110. The communication unit 1102 can provide other connections to the network 1002 and to other entities of the system 1000 using various standard communication protocols.

The input device 1104 may include any device for inputting information into the computing system 1100. In some embodiments, the input device 1104 may include one or more peripheral devices. For example, the input device 1104 may include a keyboard, a pointing device, microphone, an image/video capture device (e.g., camera), a touch-screen display integrated with the output device 1106, etc. The output device 1106 may be any device capable of outputting information from the computing system 1100. The output device 1106 may include one or more of a display (LCD, OLED, etc.), a printer, a 3D printer, a haptic device, audio reproduction device, touch-screen display, a remote computing device, etc. In some embodiments, the output device is a display which may display electronic images and data output by a processor of the computing system 1100 for presentation to a user 106, such as the processor 1104 or another dedicated processor.

The data stores 1108 are information sources for storing and providing access to data. In some embodiments, the data stores 1108 may store data associated with a database management system (DBMS) operable on the computing system 1100. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

The data stored by the data stores 1108 may organized and queried using various criteria including any type of data stored by them, such as a customer identifier, employee identifier, account identifier, IP address, rewards account number, product classification, product identifier, etc. The data stores 1108 may include data tables, databases, or other organized collections of data. Examples of the types of data stored by the data stores 1108 may include, but are not limited to the data described with respect to FIGS. 1-2C, for example.

The data stores 1108 may be included in the computing system 1100 or in another computing system and/or storage system distinct from but coupled to or accessible by the computing system 1100. The data stores 1108 can include one or more non-transitory computer-readable mediums for storing the data. In some embodiments, the data stores 1108 may be incorporated with the memory 1106 or may be distinct therefrom.

The components 1008, 1024, 1026, 200, 201, 202, and/or 203 may be communicatively coupled by the bus 1110 and/or the processor 1104 to one another and/or the other components 1102, 1106, 1108, 1114, and 1116 of the computing system 1100. In some embodiments, the components 1008, 1024, 1026, 200, 201, 202, and/or 203 may include computer logic (e.g., software logic, hardware logic, etc.) executable by the processor 1104 to provide their acts and/or functionality. In any of the foregoing embodiments, these components 1008, 1024, 1026, 200, 201, 202, and/or 203 may be adapted for cooperation and communication with the processor 1104 and the other components of the computing system 1100.

In the above description, for purposes of explanation, numerous specific details are set forth in order to provide a thorough understanding of the present disclosure. However, it should be understood that the technology described herein can be practiced without these specific details. Further, various systems, devices, and structures are shown in block diagram form in order to avoid obscuring the description. For instance, various embodiments are described as having particular hardware, software, and user interfaces. However, the present disclosure applies to any type of computing device that can receive data and commands, and to any peripheral devices providing services.

In some instances, various embodiments may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

To ease description, some elements of the system 100 and/or the methods are referred to using the labels first, second, third, etc. These labels are intended to help to distinguish the elements but do not necessarily imply any particular order or ranking unless indicated otherwise.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various embodiments described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of an entirely hardware embodiment, an entirely software embodiment, or embodiments containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and Modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats. Furthermore, the modules, routines, features, attributes, methodologies and other aspects of the disclosure can be implemented as software, hardware, firmware, or any combination of the foregoing. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment.

What is claimed is:

1. A computer-implemented method comprising:
retrieving from a data store a customer product-class mapping that maps a customer identifier of each of a multiplicity of customers to 1) a customer tier, 2) a product class interacted with by the customer via one or more of an online sales channel, a retail sales channel, and a phone sales channel, and 3) a plurality of variables characterizing an interaction of the customer associated with the customer identifier with the product class via the one or more of the online sales channel, the retail sales channel, and the phone sales channel;
generating a predictive score for each unique combination of the customer identifier, the customer tier, and the product class using one or more of predetermined online sales channel rules, predetermined retail sales channel rules, and predetermined phone sales channel rules, respectively, and the plurality of variables;
selecting a first set of customers from the multiplicity of the customers based on the predictive score and a revenue generated from the each unique combination;
generating a schedule for contacting the first set of customers based on one or more of the predictive score and the revenue; and
providing the schedule to a client device of a stakeholder for use by the stakeholder in contacting the first set of customers.

2. The computer-implemented method of claim 1, further comprising aggregating customer data associated with each customer of the multiplicity of the customers from one or more data stores storing data related to the online sales channel by:
retrieving, from the one or more data stores, first product identifiers reflecting products purchased by the customer using the online sales channel;
retrieving, from the one or more data stores, second product identifiers reflecting products that were added to a virtual cart that was subsequently abandoned without having purchased the one or more products, the virtual cart being associated with the online sales channel;
retrieving, from one or more data stores, third product identifiers reflecting product pages of products that were viewed by the customer but were not purchased using the online sales channel;
generating an entry for the customer product-class mapping for the customer identifier associated with the customer using the first product identifiers reflecting the products purchased by the customer, the second product identifiers reflecting the products added to the virtual cart, and the third product identifiers reflecting the products that were viewed by the customer but were not purchased; and
storing the entry in an aggregated data store storing the customer product-class mapping.

3. The computer-implemented method of claim 2, further comprising:
determining product classes for the products associated with the first product identifiers, the second product identifiers, and the third product identifiers;
retrieving customer tier data describing the customer tier of the customer; and
categorizing the customer by each unique product class and customer tier combination.

4. The computer-implemented method of claim 1, wherein the plurality of variables characterizing the interaction of the customer regarding a particular product includes one or more of browsing for product price, browsing for product features, browsing for product reviews, comparing the product with other products, and reviewing product details.

5. The computer-implemented method of claim 1, wherein generating the predictive score for the each unique combination of the customer identifier, the customer tier, and the product class using the predetermined online sales channel rules and the plurality of variables comprises:
estimating time spent by the customer on each of the plurality of variables associated with a particular product that the customer has indicated interest in using the online sales channel;
allocating weights to the time spent by the customer on each of the plurality of the variables based on the predetermined online sales channel rules; and
generating the predictive score for the each unique combination of the customer identifier, the customer tier, and the product class based on the weights allocated to the time spent by the customer on each of the plurality of variables.

6. The computer-implemented method of claim 1, further comprising:
determining, for the customer identifier of each customer of the multiplicity of the customers, a visit cadence score based on a number of visits by the customer to one or more pages of one or more products;
determining, for the customer identifier of each customer of the multiplicity of the customers, a purchase cadence score based on product purchase history associated with the customer identifier;
determining, for the customer identifier of each customer of the multiplicity of the customers, a revenue cadence score customer cadence score based on amount of revenue generated from purchases by the customer;
combining, for the customer identifier of each customer of the multiplicity of the customers, the visit cadence score, the purchase cadence score, and the revenue cadence score into an overall cadence score for the customer identifier;
selecting a second set of customers from the multiplicity of the customers based on overall cadence scores associated with the second set of customers; and
injecting the second set of customers into the schedule, which includes the first set of customers.

7. The computer-implemented method of claim 1, further comprising:
selecting a second set of customers from the multiplicity of the customers based on one or more of a visit cadence score, a purchase cadence score, and a revenue cadence score; and
injecting the second set of customers into the schedule, which includes the first set of customers.

8. The computer-implemented method of claim 7, wherein the first set of customers have higher priority than the second set of customers and the schedule is sorted based on the higher priority.

9. The computer-implemented method of claim 1, further comprising:
registering a plurality of stakeholder accounts for a plurality of stakeholders including the stakeholder, each stakeholder of the plurality of stakeholders being assigned to a group of customer identifiers associated with customers;
selecting for each stakeholder account of the plurality, a first subset of customer identifiers from the group of customer identifiers assigned to that stakeholder account based on 1) a predictive score for each unique combination of each customer identifier, customer tier, and product class using one or more of the predetermined online sales channel rules, the predetermined retail sales channel rules, and the predetermined phone sales channel rules, respectively, and the plurality of variables, and 2) a revenue generated from each unique combination, wherein selecting includes selecting the first set of customers from the multiplicity of the customers based on the predictive score and the revenue generated from the each unique combination; and
selecting for each stakeholder account of the plurality, a second subset of customers identifiers from the group of customer identifiers assigned to that stakeholder based on cadence scores associated with the customer identifiers of the second subset;
generating, for each stakeholder account of the plurality, a schedule for contacting certain customers of the group of customers associated with the stakeholder account based on a combination of the first subset of customers and the second subset of customers associated with the stakeholder account; and
providing, to a client device of each stakeholder account of the plurality, the schedule generated for that stakeholder account.

10. The computer-implemented method of claim 1, further comprising:
aggregating customer data of a plurality of customers from an online data store reflecting the online sales channel, a retail data store reflecting the retail sales channel, and a call center data store reflecting the phone sales channel; and
statistically analyzing the aggregated customer data of the plurality of customers to determine the multiplicity of customers from the plurality of customers whose interest in products offered by a business merchant fall within a certain interval.

11. The computer-implemented method of claim 1, further comprising aggregating customer data associated with each customer of the multiplicity of the customers from one or more data stores storing data related to the retail sales channel and the phone sales channel by:
determining a total number of orders associated with the customer;
determining a number of items included in each of the orders;
determining revenue generated by each of the orders;
determining revenue generated by each item included in each of the orders;
determining any discounts applied to each of the orders;
generating an entry for the customer product-class mapping for the customer identifier associated with the customer using the total number of orders associated with the customer, the number of items included in each of the orders, the revenue generated by each of the orders, the revenue generated by each item included in each of the orders, and any discounts applied to each of the orders; and
storing the entry in an aggregated data store storing the customer product-class mapping.

12. A computer system comprising:
one or more computer processors;
one or more computer memories storing instructions that, when executed by the one or more computer processors, cause the computer system to perform operations including:
retrieving from a data store a customer product-class mapping that maps a customer identifier of each of a multiplicity of customers to 1) a customer tier, 2) a product class interacted with by the customer via one or more of an online sales channel, a retail sales channel, and a phone sales channel, and 3) a plurality of variables characterizing an interaction of the customer associated with the customer identifier with the product class via the one or more of the online sales channel, the retail sales channel, and the phone sales channel;
generating a predictive score for each unique combination of the customer identifier, the customer tier, and the product class using one or more of predetermined online sales channel rules, predetermined retail sales channel rules, and predetermined phone sales channel rules, respectively, and the plurality of variables;
selecting a first set of customers from the multiplicity of the customers based on the predictive score and a revenue generated from the each unique combination;
generating a schedule for contacting the first set of customers; and
providing the schedule to a client device of a stakeholder for use by the stakeholder in contacting the first set of customers.

13. The computer system of claim 12, wherein the operations further include aggregating customer data associated with each customer of the multiplicity of the customers from one or more data stores storing data related to the online sales channel by:
retrieving, from the one or more data stores, first product identifiers reflecting products purchased by the customer using the online sales channel;
retrieving, from the one or more data stores, second product identifiers reflecting products that were added to a virtual cart that was subsequently abandoned without having purchased the one or more products, the virtual cart being associated with the online sales channel;
retrieving, from one or more data stores, third product identifiers reflecting product pages of products that were viewed by the customer but were not purchased using the online sales channel;
generating an entry for the customer product-class mapping for the customer identifier associated with the customer using the first product identifiers reflecting the products purchased by the customer, the second product identifiers reflecting the products added to the virtual cart, and the third product identifiers reflecting the products that were viewed by the customer but were not purchased; and
storing the entry in an aggregated data store storing the customer product-class mapping.

14. The computer system of claim 12, wherein the operations further include:
determining product classes for the products associated with the first product identifiers, the second product identifiers, and the third product identifiers;
retrieving customer tier data describing the customer tier of the customer; and
categorizing the customer by each unique product class and customer tier combination.

15. The computer system of claim 12, wherein the plurality of variables characterizing the interaction of the customer regarding a particular product includes one or more of browsing for product price, browsing for product features, browsing for product reviews, comparing the product with other products, and reviewing product details.

16. The computer system of claim 12, wherein generating the predictive score for the each unique combination of the customer identifier, the customer tier, and the product class using the predetermined online sales channel rules and the plurality of variables comprises:
estimating time spent by the customer on each of the plurality of variables associated with a particular product that the customer has indicated interest in using the online sales channel;
allocating weights to the time spent by the customer on each of the plurality of the variables based on the predetermined online sales channel rules; and
generating the predictive score for the each unique combination of the customer identifier, the customer tier, and the product class based on the weights allocated to the time spent by the customer on each of the plurality of variables.

17. The computer system of claim 12, wherein the operations further include:
determining, for the customer identifier of each customer of the multiplicity of the customers, a visit cadence score based on a number of visits by the customer to one or more pages of one or more products;
determining, for the customer identifier of each customer of the multiplicity of the customers, a purchase cadence score based on product purchase history associated with the customer identifier;
determining, for the customer identifier of each customer of the multiplicity of the customers, a revenue cadence score customer cadence score based on amount of revenue generated from purchases by the customer;
combining, for the customer identifier of each customer of the multiplicity of the customers, the visit cadence score, the purchase cadence score, and the revenue cadence score into an overall cadence score for the customer identifier;
selecting a second set of customers from the multiplicity of the customers based on overall cadence scores associated with the second set of customers; and
injecting the second set of customers into the schedule, which includes the first set of customers.

18. The computer system of claim 12, wherein the operations further include:
selecting a second set of customers from the multiplicity of the customers based on one or more of a visit cadence score, a purchase cadence score, and a revenue cadence score; and
injecting the second set of customers into the schedule, which includes the first set of customers.

19. The computer system of claim 18, wherein the first set of customers have higher priority than the second set of customers and the schedule is sorted based on the higher priority.

20. The computer system of claim 12, wherein the operations further include:
registering a plurality of stakeholder accounts for a plurality of stakeholders including the stakeholder, each stakeholder of the plurality of stakeholders being assigned to a group of customer identifiers associated with customers;
selecting for each stakeholder account of the plurality, a first subset of customer identifiers from the group of customer identifiers assigned to that stakeholder account based on 1) a predictive score for each unique combination of each customer identifier, customer tier, and product class using one or more of the predetermined online sales channel rules, the predetermined retail sales channel rules, and the predetermined phone sales channel rules, respectively, and the plurality of variables, and 2) a revenue generated from each unique combination, wherein selecting includes selecting the first set of customers from the multiplicity of the customers based on the predictive score and the revenue generated from the each unique combination; and
selecting for each stakeholder account of the plurality, a second subset of customers identifiers from the group of customer identifiers assigned to that stakeholder based on cadence scores associated with the customer identifiers of the second subset;
generating, for each stakeholder account of the plurality, a schedule for contacting certain customers of the group of customers associated with the stakeholder account based on a combination of the first subset of customers and the second subset of customers associated with the stakeholder account; and
providing, to a client device of each stakeholder account of the plurality, the schedule generated for that stakeholder account.

21. The computer system of claim 12, wherein the operations further include:
aggregating customer data of a plurality of customers from an online data store reflecting the online sales channel, a retail data store reflecting the retail sales channel, and a call center data store reflecting the phone sales channel; and
statistically analyzing the aggregated customer data of the plurality of customers to determine the multiplicity of customers from the plurality of customers whose interest in products offered by a business merchant fall within a certain interval.

22. The computer system of claim 12, wherein the operations further include aggregating customer data associated with each customer of the multiplicity of the customers from one or more data stores storing data related to the retail sales channel and the phone sales channel by:
determining a total number of orders associated with the customer;
determining a number of items included in each of the orders;
determining revenue generated by each of the orders;
determining revenue generated by each item included in each of the orders;
determining any discounts applied to each of the orders;
generating an entry for the customer product-class mapping for the customer identifier associated with the customer using the total number of orders associated with the customer, the number of items included in each of the orders, the revenue generated by each of the orders, the revenue generated by each item included in each of the orders, and any discounts applied to each of the orders; and
storing the entry in an aggregated data store storing the customer product-class mapping.
